(19) United States
(12) Patent Application Publication
(10) Pub. No.: US 2022/0000160 A1
(43) Pub. Date: Jan. 6, 2022

(54) FLAVONOID DELIVERY SYSTEM

(71) Applicant: Massey University, Palmerston North (NZ)

(72) Inventors: Abby Kerrin Thompson, Feilding (NZ); Alejandra Acevedo Fani, Palmerston North (NZ); Ali Rashidinejad, Palmerston North (NZ); Harjinder Singh, Palmerston North (NZ); Simon Derek Miller Loveday, Palmerston North (NZ); Zhigao Niu, Palmerston North (NZ)

(21) Appl. No.: 17/291,547

(22) PCT Filed: Nov. 7, 2019
(86) PCT No.: PCT/IB2019/059560

§ 371 Date: May 5, 2021

(51) Int. Cl. A23L 33/105; A23L 33/185; A23L 33/19; A23J 3/16; A23J 3/10; A23C 9/13; A23P 10/30; A23P 10/40

(52) U.S. Cl. CPC A23L 33/105; A23L 33/185; A23L 33/19; A23J 3/16; A23C 2240/15; A23C 9/13; A23P 10/30; A23P 10/40; A23J 3/10

(57) ABSTRACT

The invention relates to a flavonoid delivery system comprising a co-precipitate of a hydrophobic flavonoid and a protein. The flavonoid delivery system comprises a high ratio of flavonoid to protein, allowing food products to be fortified with relatively large amounts of flavonoid without compromising the sensory properties of the food product.

### 1. FIELD OF THE INVENTION

The invention relates generally to products comprising co-precipitates of a hydrophobic flavonoid and a protein. The co-precipitates have properties that make them especially suitable for incorporation into foods and beverages to increase their flavonoid content.

### 2. BACKGROUND OF THE INVENTION

Flavonoids are polyphenolic compounds produced as secondary metabolites by many plants. They are defined by the presence of a structure consisting of two benzene rings interconnected by a C3 connector (a heterocylic pyrane ring). The most common flavonoids include the following: rutin, naringenin and hesperetin (flavanones); apigenin (flavones); isorhamnetin, kaempferol and quercetin (flavonols); genistein and daidzein (isoflavones); epigallocatechin, epicatechin and gallocatechin (flavan-3-ols/catechins) and cyanidin, delphinidin, pelargonidin and malvidin (anthocyanins).

Many flavonoids have therapeutic and pharmacologic properties related to their antioxidant, anti-bacterial and/or anti-inflammatory qualities. Unfortunately, few people have access to the type of food supply that would allow them to enjoy the full benefits of these compounds.

For example, rutin (quercetin-3-rhamnosylglucoside) is a well-known flavonoid glycoside, plentifully found in natural sources such as buckwheat seed and fruits (especially, citrus and their rinds). The molecule comprises the flavonol quercetin and the disaccharide rutinose. Rutin possesses potent antioxidant properties on a molecular level. Due to its substantial radical-scavenging properties rutin demonstrates therapeutic and pharmacological effects such as anti-inflammatory, antidiabetic, hypolipidaemic, and anticarcinogenic.

However, a high dosage of this flavonoid compound is required in the daily diet to achieve such benefits. The current supplements (nutraceuticals) in the market recommend an oral dosage of 500 mg per day. The daily intake of flavonoids such as rutin in a typical Western diet is much lower—the median intake is 10 mg/day.

While nutraceutical supplements in the form of capsules, tablets and sachets provide benefits, they can lose efficacy due to flavonoid stability issues and may taste and/or smell unpalatable. Therefore, many people do not like to consume them, and/or forget to take them regularly enough to provide the benefits. Hence, the addition of flavonoids to food products would allow a wider range of people to benefit from their therapeutic properties.

Like many other beneficial flavonoids, rutin is quite hydrophobic. Other hydrophobic flavonoids include curcumin, hesperidin, naringenin and catechin. Unfortunately, it is difficult to fortify foods with hydrophobic flavonoids which are poorly soluble in both oil and water. Low solubility means that added flavonoids will sediment when added to liquid food products (beverages) and produce gritty textures in semi-solid or solid food. Many flavonoids can also interact with food components such as proteins and fats, changing the physicochemical and sensorial properties of the food. They can also undergo chemical and enzymatic degradation themselves. And poorly-soluble flavonoids have a very low dissolution rate as well as a limited release profile; and subsequently, low bioavailability in the human body.

Therefore, there is increasing interest in methods of encapsulating/entrapping hydrophobic flavonoids, so that they can successfully be added to food systems. A wide range of delivery systems has already been developed including emulsions, liposomes, coacervates, and gels, composed of different natural polymers, such as polysaccharides, proteins, and phospholipids. However, options are somewhat limited because of the need to use GRAS (generally regarded as safe) materials, and a strong consumer preference for natural ingredients only.

In addition, preparation of many flavonoid delivery vehicles involves chemical cross-linking and/or organic solvents such as ethanol and methanol. These are undesirable in products for human consumption and the removal of these solvents from food products is not cost-effective. These encapsulation/delivery methods also often give low encapsulation efficiency and/or loading capacity. Other processes incorporate manufacturing steps that are expensive or technically difficult to scale up.

Food proteins such as casein, whey protein, soy proteins and the like have been used extensively as components of delivery vehicles for nutraceuticals. The caseins in particular, form part of many nutraceutical delivery systems that take advantage of their micellar structure. Caseins contain micelles of about 40 to 300 nm diameter, which can encapsulate some chemical compounds, if dissociated then re-assembled in the presence of the compound to be encapsulated. Dissociation can be achieved physically, for example, using hydrostatic pressure, or chemically, such as by heating in aqueous ethanol. Casein micelles can also be dissociated under alkaline conditions.

For example, (Pan, 2014) describe the production of casein nanoparticles of about 100 nm by alkaline dissociation of sodium caseinate (NaCas), followed by the addition of acid to reach neutral pH. The addition of curcumin to an alkaline solution of NaCas, followed by neutralisation gives a product in which curcumin is encapsulated in the re-assembled casein micelles. Unfortunately, this does not provide a product that is useful for food fortification.

Firstly, the micellar structure will only reassemble at neutral pH in dilute solutions. So the process uses relatively low amounts of curcumin (1 mg/ml) and NaCas (2.0%), leaving an uneconomically large volume of supernatant to be removed before the product can be recovered. Increasing the concentration of curcumin only decreases the encapsulation efficiency (EE) of the process, which is not high, to begin with; (1 mg/ml curcumin gives an EE of only about 70%, at the longest incubation time).

Also, the product has a low loading capacity (LC), so the proportion of flavonoid in the product is low. This means that to provide a therapeutic benefit, such a large amount of product would need to be incorporated into a food, that the properties of the food would be compromised.

Accordingly, there is a need for a delivery system for hydrophobic flavonoids that goes at least partway to overcoming these challenges, or at least provides the public with a useful choice.

### 3. SUMMARY OF THE INVENTION

In one aspect the invention provides a flavonoid delivery system comprising a co-precipitate of a hydrophobic flavonoid and a protein.

In one embodiment, the co-precipitate comprises nanocrystals of a hydrophobic flavonoid entrapped in a protein matrix.

In one embodiment, the co-precipitate comprises a hydrophobic flavonoid entrapped in a protein matrix.

In one embodiment, the hydrophobic flavonoid and protein are selected such that they both precipitate from aqueous solution at, or about at the isoelectric point of the protein.

In one embodiment, the hydrophobic flavonoid has a hydrophobicity of about 2 to about 4 and/or is soluble in aqueous solution at high pH, preferably above 10.

In one embodiment the hydrophobic flavonoid is selected from the group consisting of rutin, naringenin, quercetin, curcumin, hesperidin, alpha-naphthoflavone (ANF), beta-naphthoflavone (BNF), catechin and catechin derivatives, chrysin, luteolin, myricetin and an anthocyanin.

In one embodiment the hydrophobic flavonoid is selected from the group consisting of rutin, naringenin, catechin, curcumin and hesperidin.

In one embodiment, the protein has an isoelectric point of about 4 to about 6.5, preferably about 4 to 5.5, more preferably about 4.6 or 4.6.

In one embodiment, the protein is selected from the group consisting of sodium caseinate (NaCas), soy protein isolate (SPI), pea protein isolate, denatured whey protein isolate (WPI) and milk protein isolate (MPI).

In one embodiment, the protein is sodium caseinate (NaCas).

In one embodiment, the mass ratio of protein:flavonoid in the co-precipitate is about 4:1 to about 0.5:1, preferably about 3:1 to about 0.9:1, more preferably about 2:1 to about 1:1 and most preferably, about 1:1.

In one embodiment, the co-precipitate comprises a consumable cryoprotectant, preferably selected from the group consisting of trehalose, sucrose, glucose, mannitol, lactose, fructose, and glycerol.

In one embodiment, the co-precipitate contains about 1.0 to about 5 wt % consumable cryoprotectants, preferably about 2 to about 3 wt %, more preferably 2.5 wt %.

In one embodiment, the co-precipitate comprises trehalose, preferably 2.5 wt % trehalose.

In one embodiment, the hydrophobic flavonoid in the flavonoid delivery system is at least two times, three times, five times, 10 times, 15 times, 20 times, 25 times, 30 times, 35 times, 40 times or at least 45 times more soluble in aqueous solution than the raw flavonoid.

In one embodiment, the flavonoid delivery system is a rutin:NaCas co-precipitate in which the rutin is at least four times more soluble than free rutin in aqueous solution.

In one embodiment, the flavonoid delivery system is a rutin:NaCas co-precipitate in which the rutin is at least nine times more soluble than free rutin in aqueous solution.

In one embodiment, the flavonoid delivery system is a naringenin:NaCas co-precipitate in which the naringenin is at least 20 times more soluble than free naringenin in aqueous solution.

In one embodiment, the flavonoid delivery system is a curcumin:NaCas co-precipitate in which the curcumin is at least 12 times more soluble than free curcumin in aqueous solution.

In one embodiment, the flavonoid delivery system is a catechin:NaCas co-precipitate in which the rutin is at least 40 times more soluble than free catechin in aqueous solution.

These embodiments also apply to the other aspects of the invention mutatis mutandis.

In another aspect the invention provides a process for producing a co-precipitate of a hydrophobic flavonoid and a protein, the process comprising the steps of:
(a) preparing an aqueous solution of a hydrophobic flavonoid and a protein at a starting pH of about 9 to about 12,
(b) stirring the mixture until the hydrophobic flavonoid has dissolved, while maintaining the pH at about the starting pH;
(c) optionally adding a consumable cryoprotectant to the solution and mixing until dissolved;
(d) acidifying the solution to about the isoelectric point of the protein, causing the flavonoid and protein to co-precipitate;
(e) removing the supernatant to provide the co-precipitate.

In one embodiment, the starting pH is about 10 to about 11.5, preferably about 11.

In one embodiment, a hydrophobic flavonoid is added to an aqueous solution of protein.

In one embodiment, the concentration of protein in step (a) is about 1 to about 15% (w/v), preferably about 5 to about 12% (w/v), more preferably about 10% (w/v).

In one embodiment, the aqueous solution of protein is stirred at about the starting pH for at least about 15 minutes, preferably at least about 30 minutes before addition of the hydrophobic flavonoid.

In one embodiment, the amount of hydrophobic flavonoid added to the aqueous solution of protein in step (a) is an amount that results in a concentration of about 1 to about 15% (w/v) hydrophobic flavonoid, preferably about 5 to about 12% (w/v), more preferably about 10% (w/v).

In one embodiment, protein is added to an aqueous solution of hydrophobic flavonoid. In one embodiment, an aqueous solution of hydrophobic flavonoid is mixed with an aqueous solution of protein.

In one embodiment, the aqueous solution prepared in step (a) comprises about 1 to about 15% (w/v) hydrophobic flavonoid, preferably about 5 to about 12% (w/v), more preferably about 10% (w/v).

In one embodiment, the aqueous solution prepared in step (a) comprises about 1 to about 15% (w/v) protein, preferably about 5 to about 12% (w/v), more preferably about 10% (w/v).

In one embodiment, the ratio of protein to hydrophobic flavonoid is about 4:1 to about 0.5:1, preferably about 2:1 to about 1:1, more preferably about 1:1.

In one embodiment, the hydrophobic flavonoid is added to a 10% (w/v) aqueous solution of protein at about pH 11.

In one embodiment, the solution is acidified to pH 6 or less. In another embodiment, the solution is acidified to pH 5.5 or less, preferably 5.0 or less, more preferably to 4.6.

In one embodiment, about 1.0 to about 5 w/v consumable cryoprotectant is added in step (c), preferably about 2 to about 3 w/v more preferably 2.5 w/w.

In one embodiment, the consumable cryoprotectant is trehalose.

In one embodiment, the process has an entrapment efficiency of greater than 80%, preferably greater than 90%, more preferably greater than 95% and most preferably, greater than 98%.

In one embodiment, the process has a loading capacity (LC) of about 25 to about 49%, preferably about 35 to about 49%, more preferably about 40 to about 49% and most preferably about 48%.

In one embodiment, the co-precipitate produced in step (e) is further dried to provide a powder.

In one embodiment, the co-precipitate produced in step (e) is dispersed in a phosphate solution and spray dried to provide a powder.

In another aspect the invention provides a flavonoid delivery system comprising a co-precipitate of a hydrophobic flavonoid and a protein wherein the co-precipitate has been dispersed in a phosphate solution and spray dried.

In another aspect the invention provides a composition comprising (a) a co-precipitate of a hydrophobic flavonoid and a protein, and (b) a phosphate salt.

In another aspect the invention provides a composition comprising a co-precipitate dispersed in a phosphate solution.

In one embodiment, the phosphate solution is a solution of sodium or potassium phosphate.

In one embodiment, the phosphate is monophosphate. In one embodiment, the phosphate is a diphosphate. In one embodiment, the phosphate is a polyphosphate.

In one embodiment, the phosphate is a monosodium or monopotassium phosphate. In one embodiment, the phosphate is a disodium or dipotassium phosphate. In one embodiment, the phosphate is a trisodium or tripotassium phosphate.

In one embodiment, the phosphate is selected from the group comprising disodium hydrogen phosphate, sodium dihydrogen phosphate, dipotassium hydrogen phosphate, potassium dihydrogen phosphate and sodium tripolyphosphate.

In one embodiment, the phosphate solution comprises 0.1 to 5% (w/v) phosphate salt, preferably 0.5(w/v).

In one embodiment, the phosphate solution in which the co-precipitate has been dispersed comprises about 5 to about 15% (w/v) of the co-precipitate, preferably about 7 to about 13% (w/v), more preferably about 10% (w/v).

In one embodiment, the phosphate solution in which the co-precipitate has been dispersed comprises 0.5% phosphate salt and 10% (w/v) flavonoid:protein co-precipitate.

In one embodiment, the phosphate solution in which the co-precipitate has been dispersed comprises 0.8% phosphate salt and 15% (w/v) flavonoid:protein co-precipitate.

These embodiments also apply to the other aspects of the invention mutatis mutandis.

In one aspect, the invention provides a food product including a flavonoid delivery system which comprises a co-precipitate of a hydrophobic flavonoid and a protein.

In one embodiment, the co-precipitate comprises a hydrophobic flavonoid entrapped in a protein matrix.

In one embodiment, the co-precipitate comprises nanocrystals of a hydrophobic flavonoid entrapped in a protein matrix.

In one embodiment, the flavonoid delivery system comprises a co-precipitate of a hydrophobic flavonoid and a protein wherein the co-precipitate has been dispersed in a phosphate solution and spray dried.

In one embodiment, the food product comprises about 0.1 to about 3.5 wt % of the co-precipitate of a hydrophobic flavonoid and a protein, preferably about 0.2 to about 1.2 wt %, more preferably 0.4 to about 0.7 wt %, most preferably about 0.5 wt %.

In one embodiment, the food product is a dairy product including but not limited to a yogurt, dairy food, cheese, ice-cream or sorbet, preferably yogurt.

In one embodiment, the dairy product comprises about 0.2 to about 1.2 wt % of the co-precipitate of a hydrophobic flavonoid and a protein, preferably about 0.2 to about 0.9 wt %, more preferably 0.5 to about 0.7 wt %, most preferably about 0.6 wt %.

In one embodiment the food product is a protein beverage. In one embodiment, the protein beverage comprises about 0.1 to about 0.45 (w/v) co-precipitate of a hydrophobic flavonoid and a protein, preferably about 0.15 to about 0.4, more preferably about 0.4 (w/v).

In one embodiment, the food product is a protein bar. In one embodiment, the protein bar comprises about 0.5 to about 3.5 wt % co-precipitate of a hydrophobic flavonoid and a protein, preferably about 0.7 to about 2.5 wt %, more preferably about 1.0 to about 2 wt %.

In one aspect the invention provides a food product comprising greater than about 0.10 wt % hydrophobic flavonoid, preferably greater than 0.12 wt % hydrophobic flavonoid.

In one embodiment the food product is a dairy product, preferably a yogurt. In one embodiment the food product is a yogurt comprising about 0.1 to about 0.6 wt % hydrophobic flavonoid.

### 4. BRIEF DESCRIPTION OF THE FIGURES

The invention will now be described by way of example only and with reference to the drawings in which:

FIG. 1 shows photographs of the oven-dried (top row) and freeze-dried (bottom row) rutin-NaCas co-precipitate (C) prepared in Example 1, along with the precipitates of the controls (NaCas and rutin; A & B, respectively), as well as the reference sample (untreated rutin; D).

FIG. 2 shows the size distribution of untreated rutin (A), treated rutin with no trehalose (B), Rutin-NaCas co-precipitate with no trehalose (C), treated rutin containing 2.5% (w/v) trehalose in the initial formulation (D), Rutin-NaCas co-precipitate containing 2.5% trehalose in the initial formulation (E), as set out in Example 3. Each sample was dispersed in phosphate buffer (pH 7.0) over 120 min.

FIG. 3 shows the volume % of particles larger than 1 μm after 120 min dispersion in phosphate buffer (pH 7). This data comes from the results shown in FIG. 2.

FIG. 4 provides obscuration index data for the dispersed particles of treated rutin and the rutin-NaCas co-precipitates, with and without trehalose, over 120 (A) and 12 (B) min in phosphate buffer (pH 7.0) at room temperature. RC: treated rutin (with no trehalose), RC Tr2.5: RC containing 2.5% trehalose in the initial formulation, RC Tr5: RC containing 5% trehalose in the initial formulation, SCR: the rutin-NaCas co-precipitates (with no trehalose), SCR Tr2.5: SCR containing 2.5% trehalose in the initial formulation, SCR Tr5: SCR containing 5% trehalose in the initial formulation.

FIG. 5 provides scanning electron micrographs of powders of untreated rutin (A), treated rutin with no trehalose (B), treated rutin containing 5% (w/v) trehalose in the initial formulation (C), the rutin-NaCas co-precipitates with no trehalose (D), and the rutin-NaCas co-precipitates containing 2.5 and 5% trehalose in the initial formulation (E & F, respectively). The scale bars can be found at the bottom of each micrograph. The scale bar represents 5 μm.

FIG. 6 provides X-ray diffraction patterns of powders of, from bottom to top, untreated NaCas (A), treated NaCas (B), dry-mixed of rutin and NaCas (C), the rutin-NaCas co-precipitates with no trehalose (D), treated rutin containing 2.5% (w/v) trehalose in the initial formulation (E), and the rutin-NaCas co-precipitates containing 2.5% and 5% trehalose in the initial formulation (F and G, respectively).

FIG. 7 shows the solid-state nuclear magnetic resonance spectra of the lyophilised powders of untreated (A) and treated (B) NaCas, dry-mixed of rutin and NaCas (C), the rutin-NaCas co-precipitates with no trehalose (D), the rutin-NaCas co-precipitates containing 2.5% (w/v) trehalose in the initial formulation (E), the rutin-NaCas co-precipitates containing 5% trehalose in the initial formulation (F), treated rutin containing 2.5% trehalose in the initial formulation (G), and treated rutin containing 5% trehalose in the initial formulation (H).

FIG. 8 shows the effect of pH treatment on the selected solid-state nuclear magnetic resonance spectra of rutin.

FIG. 9 shows the volume % of particles over time for catechin products dispersed in phosphate buffer, comparing the raw flavonoid (FIG. 9A), treated (FIG. 9B), treated with trehalose (FIG. 9C), treated mixed with NaCas (FIG. 9D) and co-precipitate with trehalose (FIG. 9E).

FIG. 10 shows the volume % of particles over time for curcumin products dispersed in phosphate buffer, comparing the raw flavonoid (FIG. 9A), treated (FIG. 9B), treated with trehalose (FIG. 9C), treated mixed with NaCas (FIG. 9D) and co-precipitate with trehalose (FIG. 9E).

FIG. 11 shows the volume % of particles over time for hesperidin products dispersed in phosphate buffer, comparing the raw flavonoid (FIG. 9A), treated (FIG. 9B), treated with trehalose (FIG. 9C), treated mixed with NaCas (FIG. 9D) and co-precipitate with trehalose (FIG. 9E).

FIG. 12 shows the volume % of particles over time for naringenin products dispersed in phosphate buffer, comparing the raw flavonoid (FIG. 9A), treated (FIG. 9B), treated with trehalose (FIG. 9C), treated mixed with NaCas (FIG. 9D) and co-precipitate with trehalose (FIG. 9E).

FIG. 13 shows the XRD analysis of catechin products, including untreated and treated flavonoid and co-precipitates with NaCas.

FIG. 14 shows the XRD analysis of curcumin products, including untreated and treated flavonoid and co-precipitates with NaCas.

FIG. 15 shows the XRD analysis of hesperidin products, including untreated and treated flavonoid and co-precipitates with NaCas.

FIG. 16 shows the XRD analysis of naringenin products, including untreated and treated flavonoid and co-precipitates with NaCas.

FIG. 17 shows scanning electron micrographs of powders of untreated catechin (A), treated catechin with no trehalose (B), treated catechin containing 2.5% (w/v) trehalose in the initial formulation (C), the catechin-NaCas co-precipitates (FlavoPlus) with no trehalose (D), and the catechin-NaCas co-precipitates (FlavoPlus) containing 2.5% trehalose in the initial formulation (E). The scale bars can be found at the bottom of each micrograph. The scale bar represents 5 μm. FIGS. 17i and 17ii are on different scales.

FIG. 18 shows scanning electron micrographs of powders of untreated curcumin (A), treated curcumin with no trehalose (B), treated curcumin containing 2.5% (w/v) trehalose in the initial formulation (C), the curcumin-NaCas co-precipitates (FlavoPlus) with no trehalose (D), and the curcumin-NaCas co-precipitates (FlavoPlus) containing 2.5% trehalose in the initial formulation (E). The scale bars can be found at the bottom of each micrograph. FIGS. 18i and 18ii are on different scales. The scale bar for FIG. 18i represents 5 μm. The scale bar for FIG. 18ii represents 20 μm.

FIG. 19 shows scanning electron micrographs of powders of untreated hesperidin (A), treated hesperidin with no trehalose (B), treated hesperidin containing 2.5% (w/v) trehalose in the initial formulation (C), the hesperidin-NaCas co-precipitates (FlavoPlus) with no trehalose (D), and the hesperidin-NaCas co-precipitates (FlavoPlus) containing 2.5% trehalose in the initial formulation (E). The scale bars can be found at the bottom of each micrograph. FIGS. 19i and 19ii are on different scales. The scale bars for FIGS. 19i and 19ii represent 20 μm.

FIG. 20 shows scanning electron micrographs of powders of untreated naringenin (A), treated naringenin with no trehalose (B), treated naringenin containing 2.5% (w/v) trehalose in the initial formulation (C), the naringenin-NaCas co-precipitates (FlavoPlus) with no trehalose (D), and the naringenin-NaCas co-precipitates (FlavoPlus) containing 2.5% trehalose in the initial formulation (E). The scale bars can be found at the bottom of each micrograph. FIGS. 20i and 20ii are on different scales.

FIG. 21 provides a schematic of the industrial process used to prepare yogurt including the FlavoPlus product of the invention.

FIG. 22 shows the changes in consistency (A) and firmness (B) of the set-style yoghurts fortified with different concentrations of rutin; plain (without rutin), Free (with untreated rutin), and Encap (with rutin-NaCas co-precipitate). The amount of rutin in the yogurt sample (185 g) is specified.

FIG. 23 shows the changes in pH (A) and rheological properties (B) of rutin-enriched yoghurts as a function of fermentation time for plain (without rutin), Free (with untreated rutin), and Encap (with rutin-NaCas co-precipitate).

FIG. 24 shows the changes in rutin concentration from fortified yoghurts during storage. Control (without rutin), FlavoPlus (with rutin-NaCas co-precipitate), Free rutin (with untreated rutin).

FIG. 25 show the sensory properties (acceptance) of experimental vanilla flavoured yogurt fortified with 500 mg rutin using FlavoPlus (NaCas-rutin co-precipitate) (n=45 participants).

FIG. 26 provides a schematic representation of the bench-top manufacture of a protein bar including the FlavoPlus product of the invention.

FIG. 27 provides a schematic representation of the bench-top/pilot plant manufacture of a protein beverage including the FlavoPlus product of the invention.

FIG. 28 shows the water solubility of untreated rutin, treated rutin with no trehalose, treated rutin containing 2.5% trehalose (w/v) in the initial formulation, and the co-precipitates (FlavoPlus) of rutin with different proteins (NaCas (sodium caseinate), soy protein isolate (SPI), and whey protein isolate (WPI)), with and without trehalose (2.5% trehalose w/v in the initial formulation). Columns with different letters are significantly different (p<0.05).

FIG. 29 shows the water solubility of untreated naringenin, treated naringenin with no trehalose, treated naringenin containing 2.5% trehalose (w/v) in the initial formulation, and the co-precipitates (FlavoPlus) of naringenin with different proteins (NaCas (sodium caseinate), soy protein isolate (SPI), and whey protein isolate (WPI)), with and without trehalose (2.5% trehalose w/v in the initial formulation). Columns with different letters are significantly different (p<0.05).

FIG. 30 shows the water solubility of untreated curcumin, treated curcumin with no trehalose, treated curcumin containing 2.5% trehalose (w/v) in the initial formulation, and the co-precipitates (FlavoPlus) of curcumin with different proteins (NaCas (sodium caseinate), soy protein isolate (SPI), and whey protein isolate (WPI)), with and without trehalose (2.5% trehalose w/v in the initial formulation). Columns with different letters are significantly different (p<0.05).

FIG. 31 shows the water solubility of untreated catechin, treated catechin with no trehalose, treated catechin containing 2.5% trehalose (w/v) in the initial formulation, and the co-precipitates (FlavoPlus) of curcumin with different proteins (NaCas (sodium caseinate), soy protein isolate (SPI), and whey protein isolate (WPI)), with and without trehalose (2.5% trehalose w/v in the initial formulation). Columns with different letters are significantly different (p<0.05).

FIG. 32 shows the D 50 particle size measurements of the dispersed particles of different rutin powders, measured over 120 min in phosphate buffer (pH 7.0) at room temperature. Columns with different letters are significantly different (p<0.05).

FIG. 33 shows the water solubility of untreated rutin, FlavoPlus (Rutin-NaCas with and without trehalose), and FlavoPlus dispersed in phosphate buffer (pH 7). Columns with different letters are significantly different (p<0.05).

### 5. DETAILED DESCRIPTION OF THE INVENTION

The inventors have developed a surprisingly simple way to produce a flavonoid delivery system that facilitates the ingestion of a large amount of health-promoting flavonoids in a single serving of food. The system utilises the dissolution and precipitation properties of hydrophobic flavonoids at different pH values, to produce a co-precipitate of the flavonoid with suitable proteins. The co-precipitate can be added directly to food products (either in wet or dry form) or can be dispersed in a phosphate solution and spray-dried before incorporation into a food product. The dispersed co-precipitates in phosphate solution can also be added directly into food before spray drying.

5.1 The Hydrophobic Flavonoid Delivery System of the Invention

The invention provides a flavonoid delivery system for fortification of foods and beverages. It is particularly useful for the delivery of hydrophobic flavonoids.

Flavonoids are a class of compounds having a 15-carbon skeleton consisting of two phenyl rings and a connecting heterocyclic ring. Different sub-classes are defined by differences in the degree of unsaturation and oxidation state of the heterocyclic connector.

The term “flavonoid” as used herein includes flavanols, flavonols, anthoxanthins, flavanones, isoflavones, flavones, flavans and anthocyanidines, and also encompasses isoflavonoids and neofavonoids.

The term “hydrophobic flavonoid” as used herein, means a flavonoid that has a hydrophobicity of greater than about 2. Hydrophobicity is measured as Log P, wherein P is the Partition coefficient (the solubility of the compound in 1-octanol divided by its solubility in water). Such compounds have very low solubility in aqueous solutions at neutral pH.

In one aspect the invention provides a flavonoid delivery system comprising a co-precipitate of a hydrophobic flavonoid and a protein.

In one aspect the invention provides a flavonoid delivery system consisting essentially of a co-precipitate of a hydrophobic flavonoid and a protein.

In one embodiment the hydrophobic flavonoid and protein are selected such that they both precipitate from aqueous solution at, or at about the isoelectric point of the protein.

In one embodiment, the hydrophobic flavonoid has a hydrophobicity of about 2 to about 4. In one embodiment, the hydrophobic flavonoid is soluble in aqueous solution at high pH, preferably above 10.

In one embodiment, the hydrophobic flavonoid is selected from the group consisting of rutin, naringenin, quercetin, curcumin, hesperidin, alpha-naphthoflavone (ANF), beta-naphthoflavone (BNF), catechin and catechin derivatives, chrysin, luteolin, myricetin and anthocyanins.

In one embodiment, the hydrophobic flavonoid is selected from the group consisting of rutin, naringenin, catechin, curcumin and hesperidin.

In one embodiment the flavonoid delivery system comprises co-precipitate of a hydrophobic flavonoid and a protein wherein nanocrystals of the hydrophobic flavonoid are entrapped in a protein matrix.

The nanocrystals are separated by particles of protein, which prevent the nanocrystals from growing in size and/or clumping together to any great degree. This results in a product in which the flavonoid crystals are much smaller than the micro/macro crystals present in the raw dried compound.

Without being bound by theory, it is believed that the hydrophobic flavonoid and protein present in the co-precipitate interact physically but not chemically. In other words, the hydrophobic flavonoid and protein are not covalently bound but rather have co-precipitated from solution in such a way as to provide a structure in which small flavonoid crystals are encapsulated/entrapped by precipitated protein, along with an amount of amorphous hydrophobic flavonoid.

The proportion of flavonoid present in the form of nanocrystals may vary with the actual flavonoid and protein that are co-precipitated, and with the treatment of the co-precipitated product. For example, the flavonoid component of co-precipitate dispersed in phosphate solution and spray-dried may contain a higher proportion of amorphous flavonoid entrapped in the protein matrix.

In one embodiment, the co-precipitate comprises a hydrophobic flavonoid entrapped in a protein matrix.

The hydrophobic flavonoid and the protein for use in the invention, are selected such that the flavonoid and protein both precipitate from aqueous solution at a pH that is about the same as the isoelectric point of the protein. The isoelectric point is the pH at which the protein is least soluble.

In one embodiment, the co-precipitate forms at a pH that is less than about 2 units from the isoelectric point of the protein, preferably less than about 1 unit.

In one embodiment, the protein has an isoelectric point of about 4 to about 6.5, preferably about 4 to 5.5, more preferably about 4.6.

In one embodiment, the protein is selected from the group consisting of sodium caseinate, soy protein isolate, pea protein isolate, denatured whey protein isolate and milk protein isolate.

In one embodiment, the protein is sodium caseinate (NaCas)

In one embodiment, the mass ratio of protein:flavonoid in the co-precipitate is about 4:1 to about 0.5:1.

In another embodiment, the mass ratio of protein:flavonoid is about 3:1 to about 0.9:1.

In another embodiment, the mass ratio of protein:flavonoid is about 2:1 to about 1:1.

In another embodiment, the mass ratio of protein:flavonoid is about 1:1.

In one embodiment, the co-precipitate of the invention also comprises one or more consumable cryoprotectants. Cryoprotectants can influence the properties of the co-precipitate in several ways. Because the flavonoids are polyhydroxy compounds, the presence of a cryoprotectant can result in the formation of a eutectic in aqueous solution, which modifies the ice crystalloids. The addition of a cryoprotectant can also increase the viscosity of the solution/dispersion, which suppresses ice crystallisation. Thirdly, cryoprotectants can maintain spatial orientation and distance among particles during sublimation in the freeze-drying process. This inhibits aggregation.

In one embodiment, the consumable cryoprotectant is a sugar, preferably a disaccharide. In one embodiment, the consumable cryoprotectant is selected from the group consisting of trehalose, sucrose, glucose, mannitol, lactose, fructose, and glycerol.

In one embodiment, the co-precipitate contains about 1.0 to about 5 wt % consumable cryoprotectants, preferably about 2 to about 3 wt %, more preferably 2.5 wt %.

In one embodiment, the product comprises trehalose, preferably 2.5 wt % trehalose.

The hydrophobic flavonoid delivery system of the invention has many properties that make it ideally suited for use in food products.

The co-precipitate is a dried powder material which is stable, and so can be stored at room temperature for long periods before use. However, unlike many powdered products, it can be easily incorporated into food products.

To be effective as a food ingredient, a powdered material must be able to rehydrate in aqueous media. Dispersibility (the ability of a product to disperse into single particles throughout the medium) is an important step in rehydration. The hydrophobic flavonoid delivery system of the invention is much more dispersible in aqueous solution than an equivalent hydrophobic flavonoid that has not been co-precipitated with protein.

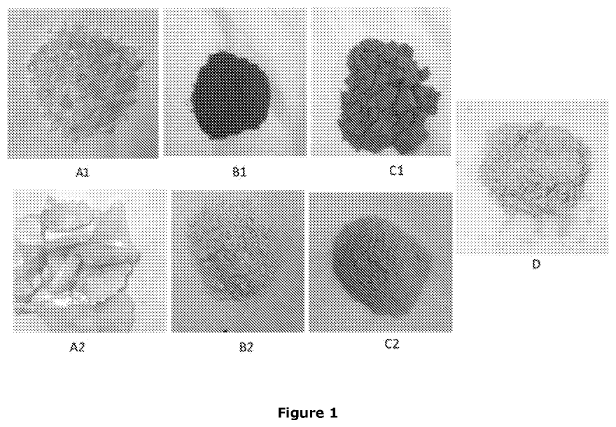

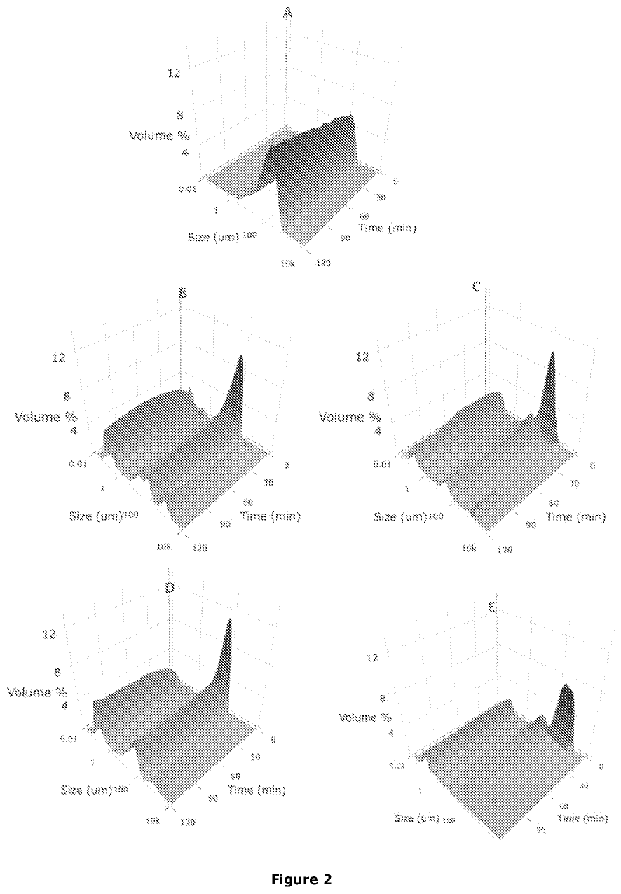

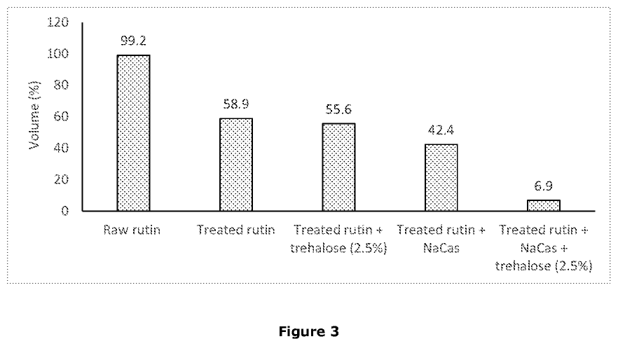

FIG. 1C shows the flavonoid delivery system of the invention, in powder form. FIG. 2 indicates that the freeze-dried co-precipitate of the invention (presented in FIG. 1C) develops a very different volume distribution to untreated rutin, when left in phosphate buffer (pH 7) over time. FIG. 3 quantifies and summarises the results of FIG. 2 for the particles bigger than 1 μm. The smaller average particle size means that in the aqueous medium, the product will disperse much more easily than would the untreated rutin. The addition of a cryoprotectant such as trehalose, enhances the effect, as does dispersing the co-precipitate in phosphate solution and spray-drying it.

In one embodiment, the co-precipitate disperses to provide a lower volume % of particles larger than 1 μm after 120 min of dispersion in phosphate buffer of pH 7, relative to a product comprising the same amount of untreated flavonoid.

In one embodiment, the co-precipitate provides a volume % of particles smaller than 1 mm after 120 min of dispersion in phosphate buffer of pH 7, that is at least 49% higher than a product comprising the same amount of untreated flavonoid; preferably at least 60% higher, more preferably about 75% higher, and most preferably about 90% higher than the product comprising the same amount of untreated flavonoid.

In one embodiment, the co-precipitate has a particle distribution after 120 min of dispersion in phosphate buffer at pH 7, such that 60% of particles have a volume of less than 1 μm.

In one embodiment, the co-precipitate has a particle distribution after 120 min of dispersion in phosphate buffer at pH 7, such that 75% of particles have a volume of less than 1 μm.

In one embodiment, the co-precipitate has a particle distribution after 120 min of dispersion in phosphate buffer at pH 7, such that 90% of particles have a volume of less than 1 μm.

In one embodiment, the co-precipitate has a dispersibility of greater than 0.5%, preferably greater than 1% in an aqueous medium.

As used herein, a dispersibility of 1% means that 1% of the powder will disperse in an aqueous medium when left for 1 hour or longer.

A relatively large amount of the flavonoid delivery systems of the invention can be added to food products because they remain completely dispersed even when present in high concentrations.

In one embodiment, the co-precipitate is completely dispersed in aqueous solution when present at a concentration of 1 to 6 wt %.

In one embodiment, the co-precipitate is completely dispersed in aqueous solution when present at a concentration of 6 wt %.

5.2 Preparation of the Flavonoid Delivery System of the Invention

The co-precipitates of the invention are prepared by utilising the properties of the hydrophobic flavonoid and the protein at different pHs. One of the advantages of the invention is the simplicity by which these co-precipitates can be prepared, at a large scale, using only consumable ingredients.

Unlike many published processes for encapsulating flavonoids, the co-precipitates of the invention can be prepared on a large scale in hours. Another advantage is that their preparation does not require nor generate large quantities of water, which would need to be removed, rendering the process uneconomical.

In one aspect, the invention provides a process for producing a co-precipitate of a hydrophobic flavonoid and a protein, the process comprising the steps of:
(a) preparing an aqueous solution of a hydrophobic flavonoid and a protein at a starting pH of about 9 to about 12,
(b) stirring the mixture until the hydrophobic flavonoid has dissolved, while maintaining the pH at about the starting pH;
(c) optionally adding a consumable cryoprotectant to the solution and mixing until dissolved;
(d) acidifying the solution to about the isoelectric point of the protein, causing the flavonoid and protein to co-precipitate;
(e) removing the supernatant to provide the co-precipitate.

The invention also provides a product produced by the above processes.

In the process of the invention, the hydrophobic flavonoid is added to an aqueous solution of protein at alkaline pH, before the pH is dropped to provide an acidic solution. It is essential that the solution becomes acidic rather than just neutral, so that the protein and flavonoid do not form a micellular structure, but instead, co-precipitate together.

A micellar-based product provides a poor delivery system because the ratio of flavonoid to protein is very low. In contrast, in the flavonoid delivery system of the invention, the hydrophobic flavonoid precipitates, preferably in the form of nanocrystals that are restricted in size due to the concomitant precipitation of the protein, which forms a matrix around the nanocrystals, preventing further growth.

In step (a) an aqueous solution of hydrophobic flavonoid and a protein is prepared, and sufficient base added to reach a pH of about 9 to about 12. One or more hydrophobic flavonoids and/or proteins may be used.

A person skilled in the art would be able to determine the ideal starting pH for the combination of flavonoid(s) and protein(s). In one embodiment the starting pH is about 9 to about 11.5, preferably about 10 to about 11.5, more preferably about 11.

In one embodiment the hydrophobic flavonoid has a hydrophobicity about 2 to about 4.

In one embodiment, the hydrophobic flavonoid is selected from the group consisting of rutin, naringenin, alpha-naphthoflavone (ANF), beta-naphthoflavone (BNF), catechin and catechin derivatives, chrysin, quercetin, anthocyanins and hesperidin.

In one embodiment, the hydrophobic flavonoid is selected from the group consisting of rutin, naringenin, catechin, curcumin and hesperidin, and is preferably rutin.

The concentrations of hydrophobic flavonoid and protein solutions used depend on the solubility of both the flavonoid and the protein at alkaline pH. If both are relatively soluble, higher concentrations can be used.

In one embodiment, solid hydrophobic flavonoid is added to an aqueous solution of protein. The concentration of protein in the aqueous solution is about 1 to about 15% (w/v), preferably about 5 to about 12% (w/v), more preferably about 10% (w/v).

In one embodiment the aqueous solution of protein is stirred at about the starting pH for at least about 15 minutes, preferably at least about 30 minutes before addition of the hydrophobic flavonoid.

In one embodiment, the amount of hydrophobic flavonoid added to the aqueous solution of protein in step (a) is an amount that results in a concentration of about 1 to about 15% (w/v) hydrophobic flavonoid, preferably about 5 to about 12% (w/v), more preferably about 10% (w/v).

Alternatively, the solid protein may be added to an aqueous solution of hydrophobic flavonoid. Or an aqueous solution of hydrophobic flavonoid may be mixed with an aqueous solution of protein.

In one embodiment, the aqueous solution prepared in step (a) comprises about 1 to about 15% (w/v) hydrophobic flavonoid, preferably about 5 to about 12% (w/v), more preferably about 10% (w/v).

In one embodiment, the aqueous solution prepared in step (a) comprises about 1 to about 15% (w/v) protein, preferably about 5 to about 12% (w/v), more preferably about 10% (w/v).

The amount of protein added is generally about equal to the amount of hydrophobic flavonoid added, i.e. less than an order of magnitude difference. If the ratio of protein to flavonoid is too low, the flavonoid may precipitate at low pH in such a way that it is not entrapped in a protein matrix and hence the EE of the process will be very low.

In one embodiment, the ratio of protein to hydrophobic flavonoid is about 4:1 to about 0.5:1, preferably about 2:1 to about 1:1, more preferably about 1:1.

In step (c) the solution is acidified to about the isoelectric point of the protein. As used herein, the term “acidified” means that acid is added to the solution until the pH is below 7. The product of the invention will not form if the solution is merely neutralised.

The pH should be lowered by addition of sufficient acid to drop the pH to below 7 in one step, rather than by a gradual addition of acid in which the pH of the solution equilibrates before further acid is added. A person skilled in the art, will be able to determine the amount of the acid required for dropping the pH to the pI point of the protein in each batch.

As discussed above, if the solution of protein and flavonoid is allowed to stand at pH 7 for any appreciable time, the two components may self-assemble to form micelles of flavonoid encapsulated with protein. Alternatively, the less soluble flavonoid may self-precipitate leaving the more soluble protein in solution.

In one embodiment, the solution is acidified to pH 6 or less. In another embodiment, the solution is acidified to pH 5.5 or less, preferably 5.0 or less, more preferably 4.6.

In one embodiment, a consumable cryoprotectant is added in step (c). In one embodiment, the consumable cryoprotectant is a sugar, preferably a disaccharide. In one embodiment, the consumable cryoprotectant is selected from the group consisting of trehalose, sucrose, mannitol, and fructose.

In one embodiment, about 1.0 to about 5 w/v consumable cryoprotectant is added in step (c), preferably about 2 to about 3 w/v more preferably 2.5 w/w.

In one embodiment, the consumable cryoprotectant is trehalose.

The process by which the product of the invention is prepared has a high entrapment efficiency (EE) for the ratio of protein to flavonoid in the product. The EE of a process that generates a material comprising a trapped agent reflects the amount of the agent that is trapped in the material relative to the total amount of agent initially used in the preparation of the material. The high EE achieved in the preparation of the co-precipitate of the invention means that more of the expensive flavonoid is entrapped within in the protein matrix.

High EEs are easily achieved in the preparation of encapsulated materials in which small volumes of flavonoid are surrounded by large protein shells. However, where the components are structured differently, such that the amounts of protein and flavonoid are more equal, an EE of greater than 80% is both highly desirable and unexpected.

In one embodiment, the process of the invention generates a co-precipitate with a mass ratio of protein:flavonoid of about 4:1 to about 0.5:1, with an EE of greater than 80%, preferably greater than 90%, more preferably greater than 95% and most preferably, greater than 98%.

In one embodiment, the process of the invention generates a co-precipitate with a mass ratio of protein:flavonoid of about 3:1 to about 0.8:1, with an EE of greater than 80%, preferably greater than 90%, more preferably greater than 95% and most preferably, greater than 98%.

In one embodiment, the process of the invention generates a co-precipitate with a mass ratio of protein:flavonoid of about 2:1 to about 0.9:1, with an EE of greater than 80%, preferably greater than 90%, more preferably greater than 95% and most preferably, greater than 98%.

In one embodiment, the process of the invention generates a co-precipitate with a mass ratio of protein:flavonoid of about 1:1, with an EE of greater than 80%, preferably greater than 90%, more preferably greater than 95% and most preferably, greater than 98%.

The loading capacity (LC) of the process of the invention is also high. The loading capacity is the proportion of flavonoid that makes it into the co-precipitate, per weight of the initial flavonoid.

In one embodiment, the process has an LC of about 25 to about 49%.

In one embodiment the process has an LC of about 35 to about 49%.

In one embodiment, the process has an LC of about 40 to about 49%.

In one embodiment, the process has an LC of about 48%.

The high EE and LC achieved in the preparation of the flavonoid delivery system of the invention makes the co-precipitates very economical to use as fortification agents, as only a small amount need be added to greatly increase the flavonoid content of the food product. The smaller amounts needed also make it less likely that the co-precipitates will affect the sensory properties of the food.

Following co-precipitation of the flavonoid and protein, the supernatant can be removed using any suitable technique or combination of techniques known in the art. For example, the centrifugation will remove much of the supernatant from the product, which can then be dried further by lyophilisation, oven drying, spray drying and the like.

In one embodiment the product is lyophilised. In another embodiment, the product is oven-dried. Once dried, the product can be milled to provide a powder. The powder is stable, and can be stored at room temperature, for later use in food fortification or other applications.

While the co-precipitate prepared in accordance with the above process has solubility and dispersibility properties that make it ideal for food fortification, an additional treatment step further improves the co-precipitate.

In one embodiment the co-precipitate produced in step (e) is dispersed in a phosphate solution and spray dried to provide a powder.

Following removal of the supernatant, the co-precipitate may be dispersed in a phosphate solution and spray dried.

Accordingly, in one aspect, the invention also provides a process for producing a co-precipitate of a hydrophobic flavonoid and a protein, the process comprising the steps of:
(a) adding a hydrophobic flavonoid to an aqueous solution of the protein at a starting pH of about 9 to about 12;
(b) stirring the mixture until the hydrophobic flavonoid has dissolved, while maintaining the pH at about the starting pH;
(c) optionally adding a consumable cryoprotectant to the solution and mixing until dissolved;
(d) acidifying the solution to about the isoelectric point of the protein, causing the flavonoid and protein to co-precipitate;
(e) removing the supernatant to provide the co-precipitate;
(f) dispersing the co-precipitate in a phosphate solution;
(g) spray drying the dispersed co-precipitate.

The invention also includes the products of the above process.

In one aspect the invention provides a flavonoid delivery system comprising a co-precipitate of a hydrophobic flavonoid and a protein wherein the co-precipitate has been dispersed in a phosphate solution and spray dried.

In another aspect the invention provides a composition comprising (a) a co-precipitate of a hydrophobic flavonoid and a protein, and (b) a phosphate salt.

In another aspect the invention provides a composition comprising a co-precipitate dispersed in a phosphate solution.

In one embodiment, the phosphate solution is a solution of sodium or potassium phosphate.

In one embodiment, the phosphate monophosphate. In one embodiment, the phosphate is a diphosphate. In one embodiment, the phosphate is a polyphosphate.

In one embodiment, the phosphate is a monosodium or monopotassium phosphate. In one embodiment, the phosphate is a disodium or dipotassium phosphate. In one embodiment, the phosphate is a trisodium or tripotassium phosphate.

In one embodiment, the phosphate is selected from the group comprising disodium hydrogen phosphate, sodium dihydrogen phosphate, dipotassium hydrogen phosphate, potassium dihydrogen phosphate and sodium tripolyphosphate.

The optimal concentration of the phosphate solution depends on the concentration of flavonoid:protein co-precipitate that is to be dispersed in the solution.

In one embodiment, the phosphate solution comprises 0.1 to 5% (w/v) phosphate salt.

In one embodiment, the phosphate solution to which the co-precipitate has been added comprises 0.5% phosphate salt and 10% (w/v) flavonoid: protein co-precipitate.

In one embodiment, the phosphate solution to which the co-precipitate has been added comprises 0.8% phosphate salt and 15% (w/v) flavonoid: protein co-precipitate.

In one embodiment, the phosphate solution to which the co-precipitate has been added comprises about 5 to about 15% (w/v) of the co-precipitate, preferably about 7 to about 13% (w/v), more preferably about 10% (w/v).

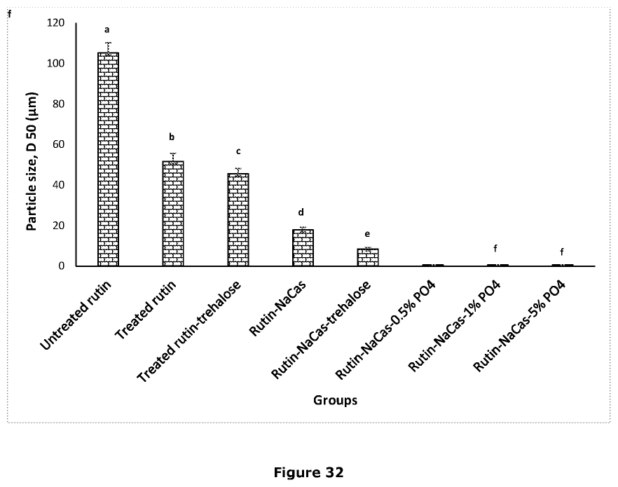

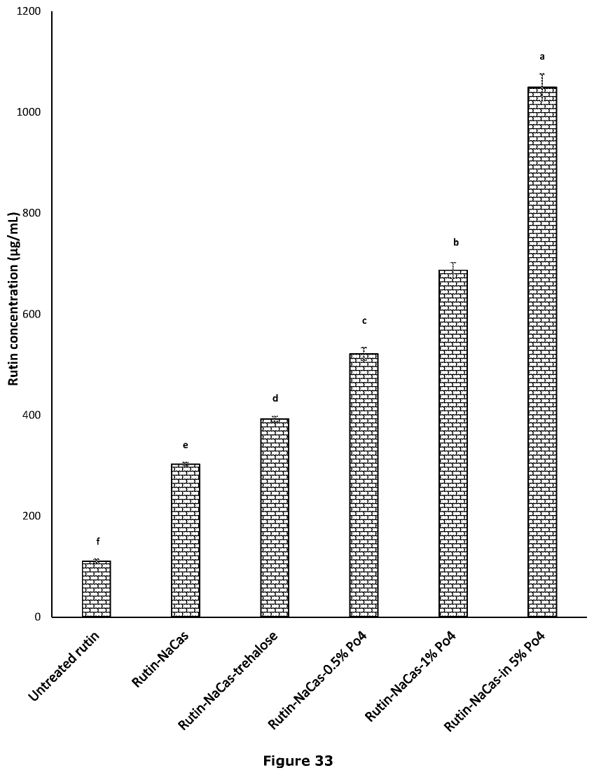

Dispersion of the co-precipitate in phosphate solution followed by spray drying provides co-precipitates of even higher dispersibility and solubility, as shown in FIGS. 32 and 33.

In one embodiment, the flavonoid delivery system has a dispersibility (D 50 measured over 120 minutes) that is at least 100 times, 150 times or at least 200 times greater than the dispersibility of the untreated flavonoid.

5.3 Food Products Comprising the Flavonoid Delivery System of the Invention

The flavonoid delivery system of the invention can be used in many applications. It is especially useful for incorporation into food and nutraceutical products.

The delivery system co-precipitate can be incorporated into a range of food products (including liquid, solid and semi-solid food products) as a fortifying agent to increase the content of health enhancing flavonoid in the food.

In one aspect, the invention provides a food product including a flavonoid delivery system which comprises a co-precipitate of a hydrophobic flavonoid and a protein.

In one embodiment the co-precipitate comprises nanocrystals of a hydrophobic flavonoid entrapped in a protein matrix.

In one embodiment the co-precipitate comprises a hydrophobic flavonoid entrapped in a protein matrix.

In one embodiment, the flavonoid delivery system comprises a co-precipitate of a hydrophobic flavonoid and a protein wherein the co-precipitate has been dispersed in a phosphate solution and spray dried.

In one embodiment, the flavonoid delivery system is a composition comprising a co-precipitate of a hydrophobic flavonoid and a protein, and a phosphate salt

The flavonoid delivery system of the invention is particularly suited for incorporation into dairy products including but not limited to yogurt, dairy food, cheese, ice-cream, sorbet, jellies, single-served shot products, honey and honey-based products, and the like; protein bars; powdered beverages, beverages, in particular, semi-solid protein beverages such as smoothies and shakes: cereals; and spreads, for example, peanut butter.

The co-precipitate is not well-suited for use in clear beverages, as it will provide opaqueness when added. But it is ideal for opaque food products including beverages, particularly food products and beverages that already contain protein.

Relatively large amounts of the co-precipitate of the invention can be incorporated into these food products to improve their health potential, without compromising their sensory properties.

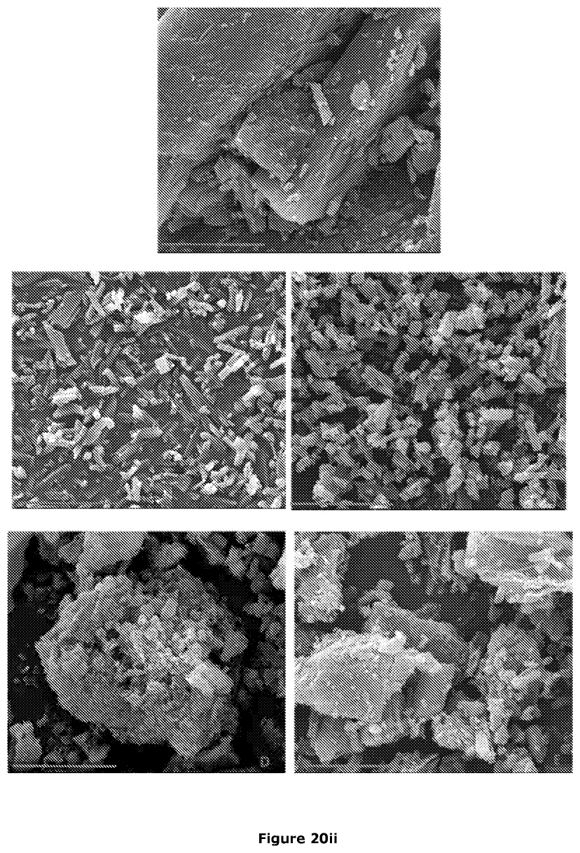

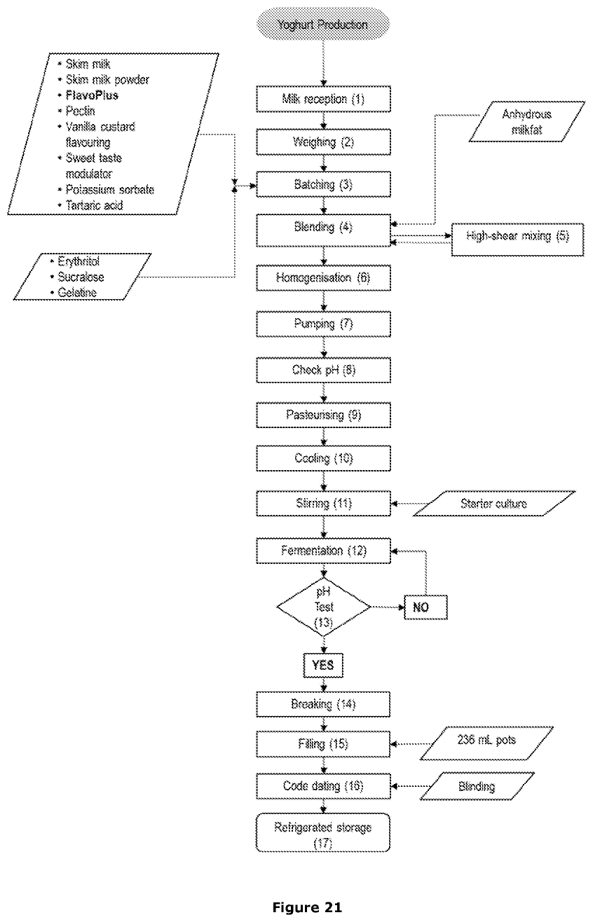

For example, protein:flavonoid co-precipitates can be incorporated into yogurt using the process outlined in FIG. 21. The industrial process includes the following main steps:
1) Pasteurized skim milk is received and stored.
2) Ingredients are weighted; the exact weigh is recorded in the weigh sheet.
3) Skim milk is warmed up to 45° C. in a tank.
   Ingredients in section A are premixed. Premix is added to milk. Mixture is heated to 60° C.
   Ingredients in section B are premixed. Premix is added to milk.
4) Mixture is stirred for 1 h at 60° C. Milkfat is added 30 min before completing the stirring step.
5) Mixture is recirculated through a triblender to integrate fat globules.
6) Mixture is homogenised at 200 bar, 1-stage.
7) Homogenised mixture is pumped to an empty tank.
8) The pH of the mixture is measured and adjusted to 6.3 with potassium hydroxide 30%.
9) Mixture is pasteurised at 85° C. for 30 min.
10) Mixture is cooled to 42° C.
11) Starter culture is added to the mixture and stirred for 15 min.
12) Agitator and heating system are shut off and the mixture i allowed to ferment for 7-8 hrs.
13) After 7 hrs, bacterial growth is monitored by measuring pH until target pH (4.6) is reached.
14) Product is cooled to 10° C. with stirrers on.
15) Product is pumped to the filling machine, where 190 g of yoghurt is added to the pots. Pots are then heat-sealed with blue lids.
16) Code date: BB is 35 days from the packaging date.
17) Product is stored at 1-4° C.

The hydrophobic flavonoid:protein co-precipitate of the invention allows a much higher concentration of flavonoid to be included in the food, without compromising its sensory or storage properties. For example, using the rutin-NaCas co-precipitate delivery system, yogurt can be fortified with up to 500 mg rutin per serve (185 g). Untreated rutin cannot be used at this concentration without causing undesirable changes to the yogurt. As demonstrated in Example 10, yogurt production is not compromised by the inclusion of the co-precipitated product, unlike the use of raw rutin.

In one embodiment, the food product comprises about 0.1 to about 3.5 wt % of the co-precipitate of a hydrophobic flavonoid and a protein, preferably about 0.2 to about 1.2 wt %, more preferably 0.5 to about 0.7 wt %, most preferably about 0.5 wt %.

In one embodiment the food product is a dairy product including but not limited to a yogurt, dairy food including dairy powders, cheese, ice-cream or sorbet, preferably yogurt.

In one embodiment, the dairy product comprises about 0.2 to about 0.9 wt % of the co-precipitate of a hydrophobic flavonoid and a protein, preferably about 0.4 to about 0.7 wt %, more preferably about 0.6 wt %. In one embodiment the dairy product is a yogurt.

In one embodiment, the food product is a protein beverage. In one embodiment, the protein beverage comprises about 0.1 to about 0.45 (w/v) co-precipitate of a hydrophobic flavonoid and a protein, preferably about 0.15 to about 0.4, more preferably about 0.4 (w/v).

In one embodiment, the food product is a protein bar. In one embodiment, the protein bar comprises about 0.5 to about 3.5 wt % co-precipitate of a hydrophobic flavonoid and a protein, preferably about 0.7 to about 2.5 wt %, more preferably about 1.0 to about 2 wt %.

In one aspect the invention provides a food product comprising greater than about 0.10 wt % hydrophobic flavonoid, preferably greater than 0.12 wt % hydrophobic flavonoid. In one embodiment the food product is a dairy product, preferably a yogurt.

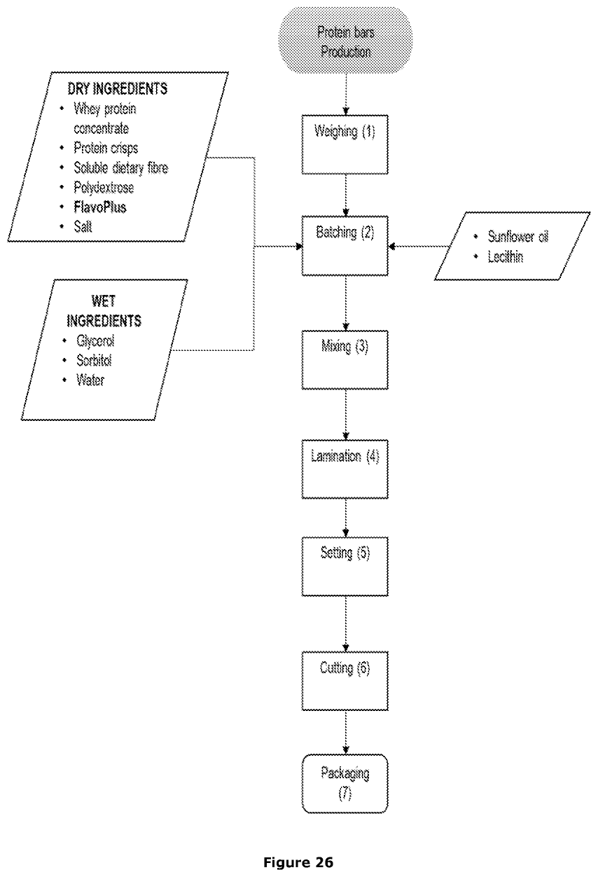

Manufacture of a protein bar fortified with rutin-NaCas co-precipitate is outlined in FIG. 26. The process includes the following main steps:
1) Dry ingredients, including the product of the invention, are weighted into a bag. Wet ingredients are weighted into a saucepan. Sunflower oil and lecithin are weighted in a separate container.
2) Dry ingredients are added to wet ingredients with constant mixing at 60° C. Sunflower oil and lecithin are added into the mixture at 60° C.
3) The blend is mixed in a Hobart style mixer for 1 minute.
4) The paste is pressed within a tray lined with baking paper, covered with plastic film or baking paper and rolled into a flat shape.
5) The product is set overnight.
6) Protein bars are cut into 55 g pieces.
7) Bars are vacuum packed.

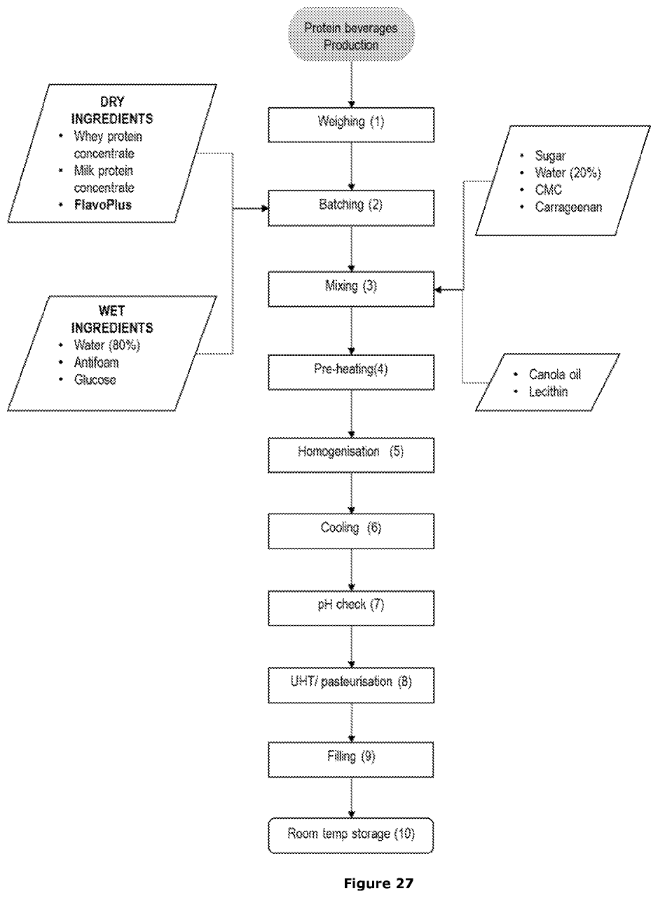

The product of the invention is also suitable for use in protein beverages, using the process set out in FIG. 27. The main steps are:
1) Wet ingredients are weighted and heated to 50° C. Dry ingredients, including the product of the invention, are weighted separately.
2) Dry ingredients are gradually added to wet ingredients.
3) Mixture is stirred at low speed for 30 min, 50° C. Sugar, water, CMC and carrageenan are premixed and added into the mixture. Oil and lecithin are pre-warmed and added to the main mixture. Keep mixing for 10 minutes.
4) Beverage is heated to 60° C.
5) Beverage is homogenised at 200/50bar, 2-stage.
6) Homogenised product is cooled to 20-25° C.
7) The pH is adjusted to 6.8 with 30% potassium hydroxide.
8) Beverage is heat-treated by UHT (140° C., 9 seconds) or pasteurisation (85° C., 15 seconds).
9) Beverage is pumped to a filling machine and aseptically packed in 250 mL plastic bottles.
10) Product can be stored at room temperature or 4° C., depending on the heat treatment applied.

While the delivery system product of the invention is particularly suited for food fortification, it may also be used as a dietary supplement. A dietary supplement is generally in the form of a pill, capsule, tablet, sachet, gels, or liquid, taken separately or with food to supplement the diet.

In one aspect the invention provides a dietary supplement comprising a flavonoid delivery system of the invention.

As used herein the term “comprising” means “consisting at least in part of”. When interpreting each statement in this specification that includes the term “comprising”, features other than that or those prefaced by the term may also be present. Related terms such as “comprise” and “comprises” are to be interpreted in the same manner.

The term “consisting essentially of ” or as used herein means the specified materials or steps and those that do not materially affect the basic and novel characteristic(s) of the claimed invention. In this specification where reference has been made to patent specifications, other external documents, or other sources of information, this is generally to provide a context for discussing the features of the invention. Unless specifically stated otherwise, reference to such external documents is not to be construed as an admission that such documents, or such sources of information, in any jurisdiction, are prior art, or form part of the common general knowledge in the art.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

Whenever a range is given in the specification, for example, a temperature range, a time range, or a composition range, all intermediate ranges and subranges, as well as all individual values included in the ranges given are intended to be included in the disclosure. In the disclosure and the claims, “and/or” means additionally or alternatively. Moreover, any use of a term in the singular also encompasses plural forms.

The term “about” as used herein means a reasonable amount of deviation of the modified term such that the end result is not significantly changed. For example, when applied to a value, the term should be construed as including a deviation of+/−5% of the value.

### 6. EXAMPLES

6.1 Materials and Methods

Chemicals

Rutin was purchased from Sigma-Aldrich (Castle Hill, NSW, Australia). According to the manufacturer, the product had a purity of >97%, w/w. Sodium caseinate was from Fonterra Co-operative Ltd. (Auckland, New Zealand). D-(+)-Trehalose dihydrate (from Saccharomyces cerevisiae, ≥99%) was a product from Sigma-Aldrich (Auckland, New Zealand). All other chemicals or reagents used were of analytical-reagent grade, obtained from either Sigma-Aldrich (Auckland, New Zealand) or Thermo Fisher Scientific (Auckland, New Zealand).

Entrapment Efficiency (EE) and Loading Capacity (LC) Determination

To measure the amount of flavonoid entrapped inside NaCas precipitates (entrapment efficiency), the concentration of flavonoid in the supernatants was determined by high pressure liquid chromatography (HPLC) following the method of (Dammak, 2017). The HPLC was equipped with a UV/visible diode array detector (Agilent Technologies, 1200 Series, Santa Clara, Calif., USA). The column was a reverse-phase Prevail™ C18 with the dimensions of 4.6 cm×150 mm, and 5 μm particle size (Grace Alltech, Columbia, Md., USA). The mobile phase consisted of acidic Milli-Q water (pH 3.50, 1% acetic acid v/v) and methanol at the volume ratio of 50:50 and a flow rate of 1 mL/min with the sample injection volume of 5 μL. Rutin, for example, was detected at 356 nm at a retention time of about 4.8 min. For the calibration of the HPLC column and quantification of rutin in the samples, standard solutions (0.01-1 mg/ml) of pure rutin (>97%) in the mobile phase were used.

To release the total fraction of the remaining rutin, the supernatants were disrupted in heated ethanol (70° C.) and filtered (0.45 μm; Thermo Scientific, Waltham, Mass., USA) before injecting to the HPLC column. Rutin is soluble in ethanol at a concentration of about 4% w/v. Finally, the EE of rutin in the rutin-NaCas co-precipitates was calculated using the following equation:

EE (%)=(Cₜₒₜₐₗ−Cₛᵤₚ)/Cₜₒₜₐₗ×100 (1)

where, Cₜₒₜₐₗ is the total (initial) concentration of rutin in the system, and Cₛᵤₚ is the rutin concentration in the supernatant. The LC of rutin was calculated according to the method from Ahmad et al. (2016) using the following equation;

LC (%)=(Total rutin−Free rutin)/weight of co-precipitates×100 (2)

The EE and LC of other flavonoids entrapped in sodium caseinate were calculated analogously.

Dispersibility of the Co-Precipitates in the Neutral pH Condition

The freeze-dried precipitates of each flavonoid and the protein, as well as the flavonoid-protein co-precipitates were dispersed in phosphate buffer (pH 7.0) and left stirring at 2000 rpm for 120 min over which the size properties (dispersibility) of the particles were studied. As suggested by (Fang, 2011), after the surface materials from particles are released in the aqueous medium, over time, the dispersion process of these particles can mimic the decrease in size of such particles. That means, measuring the size of the particles of a specific powder over a specific period of time (e.g., 120 minutes) in an aqueous medium, is an indication of the dispersion behaviour of that powder in the food products with the same medium.

Thus, the change in the size of the particles during distribution in phosphate buffer (pH 7.0) and during agitation was used as an applicable technique to observe the dispersion behaviour of the co-precipitates of protein and flavonoid or precipitate of flavonoid (control) over time, according to the method from (Ji, 2016).

A Malvern Mastersizer 3000 (Malvern Instruments Ltd, Worcestershire, UK) equipped with a 4 mW He-Ne laser operating was used. About 30 mg of each powder was weighed (to achieve the ideal level of obscuration in the instrument), added to phosphate buffer (pH 7.0) in the dispersion unit, and agitated (2000 rpm) for the whole dispersion period (120 min). The wavelength of 632.8 nm was used to continuously measure the particle size properties at 2-min intervals. Size distributions, D 50 (μm), and obscuration values for each measurement were collected and analysed. To avoid the artefact of the initial dispersion, the first measurement (Time 0) was discarded and the data from 2 to 120 min were collected. For validity of the measurements, the obscuration was monitored over the 120-min period.

Solubility of the Flavonoid when Co-Precipitated with Protein

A known amount of each powder was added to 10 mL of the aqueous medium used for the dispersibility experiment and stirred for 24 h. The samples were then centrifuged (3000×g, 20° C., 10 min) and the supernatant was collected and filtered (0.45 μm; Thermo Scientific, Waltham, Mass., USA). The soluble flavonoid in the supernatant was then extracted in ethanol and quantified using the high pressure liquid chromatography (HPLC) method described below, following the method of (Dammak, 2017).

The HPLC machine was equipped with UV/Visible and diodray detectors (Agilent Technologies, 1200 Series, Santa Clara, Calif., USA). The column was a reverse-phase Prevail™ C18 with the dimensions of 4.6 cm×150 mm, and 5 μm particle size (Grace Alltech, Columbia, Md., USA). The mobile phase consisted of acidic Milli-Q water (pH 3.50, 1% acetic acid, v/v) and methanol at the volume ratio of 50:50 and a flow rate of 1 mL/min with the sample injection volume of 5 μL. Each flavonoid was detected at its specific wavelength when eluted at a specific retention time.

For the calibration of the HPLC column and quantification of flavonoid in the samples, standard solutions (0.01-1 mg/ml) of pure flavonoids (>97%) in the mobile phase were used and the standard curves were plotted accordingly. The chromatographic peaks of analytes were obtained by comparison of retention times with the standard and peak integration using the external standard method.

To release the total fraction of the remaining flavonoid, the supernatants were disrupted in heated ethanol (70° C.) and filtered (0.45 μm; Thermo Scientific, Waltham, Mass., USA) before injecting to the HPLC column.

Morphology of the Co-Precipitates Using Scanning Electron Microscopy (SEM)

An environmental scanning electron microscope (FEI Quanta 200, The Netherlands) was used to study the morphology of the lyophilised powders. Small amounts of the milled lyophilised (apart from untreated rutin, which was a commercial sample) samples were mounted onto aluminium stubs using double-sided tape (stuck to them). When the backing was peeled off, the sample was scooped onto the exposed tape and any excess sample was puffed off. Afterwards, the samples were sputter-coated with approximately 100 nm of gold (Baltec SCD 149 050 sputter coater), and then viewed under the microscope at an accelerating voltage of 20 kV.

X-Ray Diffraction (XRD) of the Lyophilised Powders

The XRD analysis was performed at 20.0° C. on a Rigaku RAPID image-plate detector (Rigaku, The Woodlands, Texas, USA) set at 127.40 mm. Cu Kα radiation (λ=1.540562 Å) generated by a Rigaku MicroMax007 Microfocus rotating anode generator (Rigaku, USA) and focused by an Osmic-Rigaku metal multi-layer optic device (Rigaku, USA), was used. Lyophilised milled samples were mounted in Hampton CryoLoops (Hampton Research, CA, USA) with a tiny amount of Fomblin oil. Data collection was under control of RAPID II software (Version 2.4.2, Rigaku, USA), where the data were background-corrected and converted to a line profile with the 2DP programme (Version 1.0.3.4, Rigaku, USA), and compared using CrystalDiffract software (Version 6.5.5, CrystalMaker Software Ltd., Oxfordshire, UK). As sample sizes in the cryo-loops were variable, data were scaled to the same rise in the background caused by beam-stop shadow. All samples were analysed in the 2θ angle range of 5° to 100°. A narrow oscillation range of 5° was used in order to highlight the number of crystals in the X-ray beam.

Solid-State Nuclear Magnetic Resonance Spectroscopy (NMR)

Solid-state NMR spectra were acquired on a Bruker BioSpec spectrometer (Elektronik GmbH, Rheinstetten, Germany) which was operated at a ¹³C frequency of 50.39 MHz. The experiment was carried out at 22° C. using a Bruker 7-mm double resonance H/X SB-MAS (magic angle spinning) probe. 150 mg of the lyophilised milled samples was packed into a 7 mm rotor with a water-tight cap. The 90° pulse was set to 5.54 μs and a 45 kHz dipolar proton decoupling was employed during all acquisitions. The spinning speed of the rotor was 4000 Hz±10 Hz. Glycine was used as an external reference for all ¹³C chemical shifts. The spectra were processed using a 30 Hz Lorentzian line broadening and a 30 Hz Gaussian broadening.

Statistical Analysis

Samples were prepared in triplicate and all measurements were repeated three times (despite X-ray and NMR data). Mean values of data and standard deviations were calculated using Excel 2016 (Microsoft Redmond, Va., USA) and significant differences between treatments were evaluated using SPSS 20 Advanced Statistics (IBM, Armonk, N.Y., USA) at 181 p<0.05.

### Example 1

### Preparation of Rutin-NaCas Co-Precipitate (FlavoPlus)

One litre of a 10% (w/v) aqueous solution of sodium caseinate (NaCas) was prepared and left to fully hydrate overnight. The solution was then brought to pH 11.0 using 4 M NaOH and left stirring (300 rpm) at room temperature for 30 min for the complete dissociation of NaCas. 100 g (10%, w/v) of food-grade rutin was added to this solution and the pH was increased to 11.0 again, as rutin decreased the pH dramatically. The mixture was stirred at room temperature until all of the added rutin was dissolved while the pH of the solution was constantly monitored and adjusted to 11.0, when required. From the time that all of the rutin was dissolved in the NaCas solution, the mixed solution was stirred for another 30 min while the pH was continually monitored. Trehalose was added to the solution 2.5% w/v and stirred for 10-20 minutes to dissolve.

The solution (containing rutin, NaCas, and trehalose) was acidified rapidly to pH 4.6 (the pI of caseins) using 4 M HCl, causing the rutin and NaCas to co-precipitate. The resulting mixture was centrifuged at 3000 g at room temperature for 10 min. The supernatant was collected for quantification of the remaining (unentrapped) rutin. Some of the precipitate was oven-dried (50° C. for 8 hours) and some lyophilised after freezing at ˜18° C. The dried products were finely milled using a coffee grinder.

Control precipitates of both rutin and NaCas were prepared using the same process and at the same concentrations of each (i.e. 10% w/v). Following the acidification of the respective solutions, both rutin and NaCas formed precipitates, which were also subjected to the milling process. These are “treated rutin” and “treated NaCas”.

To elucidate how the precipitation process affected the microstructure, dry powders of rutin, NaCas, and/or trehalose were mixed together in the same proportions as the co-precipitates.

FIG. 1 shows the appearance of the powders produced in Example 1. While oven drying produced dark, grainy powders, lyophilising gave lighter, lower density material which was more flowable.

### Example 2

### Entrapment Efficiency (EE) and Loading Capacity (LC) Determination of Rutin After the Manufacture Process of FlavoPlus

HPLC analysis of the rutin-NaCas co-precipitate prepared in Example 1 gave an average mass ratio of 1:1 rutin-NaCas. The EE and LC of the process of Example 1 were measured in accordance with the procedures described above. The process was found to have an EE of 98.1±1.2% with an LC of 48.6±1.2%.

### Example 3

### Dispersibility of Rutin-NaCas Co-Precipitate

The dispersibility of a rutin-NaCas co-precipitate prepared in Example 1 was measured in accordance with the method provided above, and compared with (a) untreated rutin (raw commercial rutin with >97% purity obtained from sigma), and (b) treated rutin (rutin dissolved at pH 11.0 and then precipitated at pH 4.6).

The treated rutin and Flavoplus co-precipitates were tested with and without trehalose (see FIG. 2). The untreated rutin (FIG. 2A) did not show any significant dispersibility and the particle size changed very little over 120 min. All lyophilised powders had a smaller initial particle size than the untreated rutin, and particle size distributions were polydisperse in most cases. For the treated rutins (FIGS. 2B and 2D), the particle size decreased substantially over the first 60 min, although some aggregation also occurred. The improved dispersibility was more apparent with the lyophilised rutin-NaCas co-precipitates (FIGS. 2C and 2E) especially for the samples lyophilised in the presence of trehalose (FIG. 2E).

As can be seen in FIG. 3, the percentage of large particles is greatly reduced in the rutin-NaCas products, compared to both raw and treated rutin. This indicates that the co-precipitates will have much greater dispersibility.

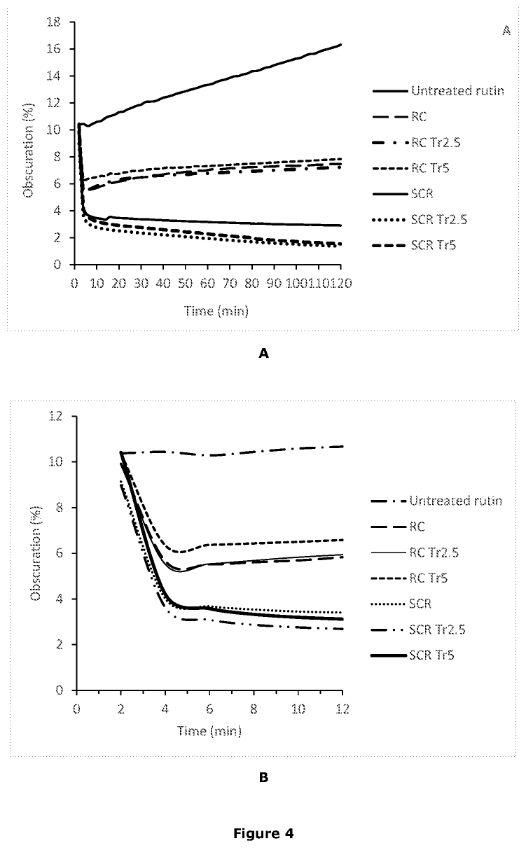

The obscuration index for untreated rutin was approximately constant over 120 min (FIG. 4), indicating no change in the total amount of scattering, i.e. the number of undissolved powder particles. For all lyophilised samples, obscuration decreased rapidly in the first 10 min and plateaued thereafter. Obscuration for samples without NaCas plateaued at ˜7% obscuration, whereas for samples lyophilised with NaCas the obscuration was 1-3%, which is consistent with particle size distributions presented in FIG. 2. Adding trehalose accelerated dissolution significantly, as shown by an earlier drop in the obscuration index.

### Example 4

### SEM of Rutin-NaCas Co-Precipitates

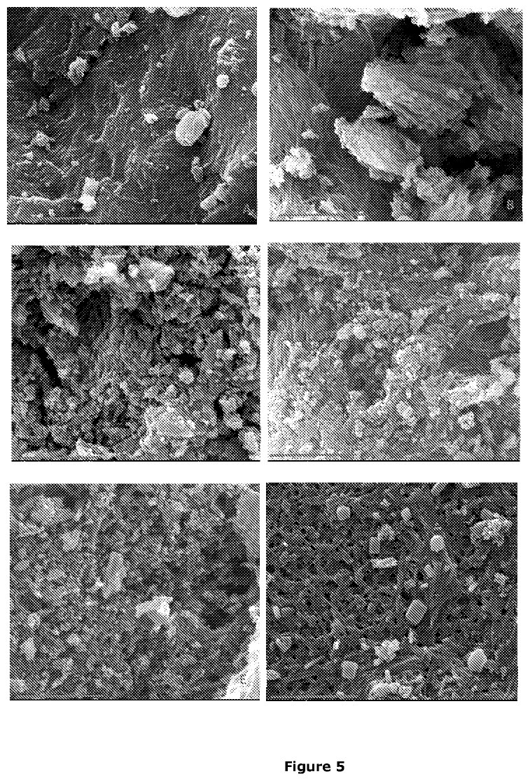

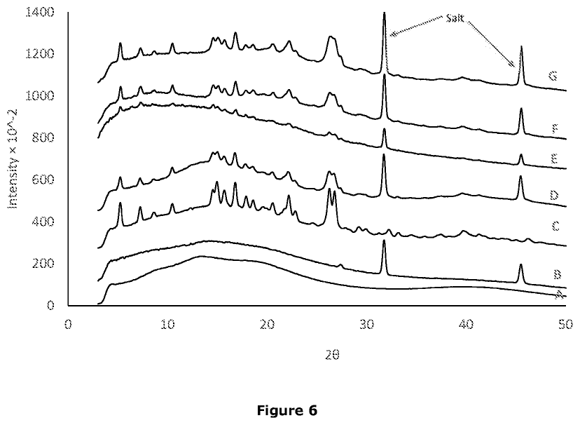

SEMs of the rutin-NaCas co-precipitates prepared in Example 1 confirmed the dispersibility results obtained in Example 3. As can be seen in FIG. 5, the morphology of both the rutin and NaCas changed following dissociation at alkaline pH and precipitation at pH 4.6. The fibrous/rod-shaped crystals seen in the micrograph of the rutin-NaCas co-precipitate (FIGS. 5D and 5E) indicate that rutin is modified in the structure of the product. The rutin crystals are different from the crystals of untreated rutin (FIG. 5A) or the mixture of untreated rutin and NaCas (FIG. 5C).

### Example 5

### X-Ray Diffraction (XRD) of Rutin-NaCas Co-Precipitate

X-ray diffractograms of treated and untreated rutin and NaCas are compared with the rutin-NaCas co-precipitate of the invention in FIG. 6.

The XRD patterns of untreated rutin showed a highly crystalline nature, whereas treated rutin was substantially less crystalline (but still somewhat spotty in the 2D diffractogram). This means that, on treatment, some of the big crystals in untreated rutin have changed to either smaller crystals (e.g. nanocrystals) and/or an amorphous state, in agreement with the morphology findings reported in FIG. 5, where SEM micrographs showed that the treated rutin exhibited a different microstructure to its untreated form.

A comparison of the XRD patterns of the rutin-NaCas co-precipitate with the untreated rutin, further explains why the co-precipitate has higher dispersibility in phosphate buffer. As can be seen in FIG. 6, the XRD patterns of untreated and treated NaCas showed an amorphous pattern, confirming that NaCas is in an amorphous state, whether treated or not.

However, sharp peaks were observed, particularly at diffraction angles of about 2θ=31° and 45° in the case of the treated NaCas. These peaks are associated with salt

(NaCl) crystals, as indicated in FIG. 6, and were expected as the treatment process first involved dissolution at pH 11 with 4 M NaOH followed by precipitation at pH 4.6 with 4 M HCl, followed by lyophilisation. Such peaks were also seen in the diffractograms of all of the other treated samples including treated rutin or the rutin-NaCas co-precipitates, as seen in FIG. 6, confirming that they are related to the added ions during the pH-treatment and precipitation process.

When the XRD patterns of the untreated dry-mixed of rutin and NaCas were compared with their co-precipitates (FIGS. 6, C & D, respectively), the peaks of the rutin-NaCas co-precipitates were broader (most apparent in the loss of resolution of closely spaced peaks at ˜15° and 26°), meaning that the treatment has resulted in less crystalline rutin in the co-precipitates. This is consistent with XRD patterns of the commercial and treated control rutin. The XRD patterns of rutin and NaCas can be seen in the patterns of the dry mixture of both (FIG. 6C). However, weaker peaks of rutin are lost in part due to broadening on the loss of crystallinity and in part to superposition of the scattering by amorphous NaCas. In other words, the XRD pattern of NaCas exists in the background, since the sample with no casein (treated rutin) appeared as a different pattern to that of rutin-NaCas co-precipitates (FIG. 6). Further, NaCas appears to have limited the growth of rutin crystals during precipitation or lyophilisation by making barriers between rutin crystals so that they do not attract each other as they do in the absence of NaCas.

### Example 6

### Solid-State NMR of Rutin-NaCas Co-Precipitate

The line-shapes of solid-state NMR spectra peaks are sensitive to changes in the chemical shift anisotropy (CSA) due to the much lower molecular mobility of molecules and groups of atoms compared to the solution state. The CSA is dependent on the orientation and shape of the electron field around the nuclei. The line-shape of the peak will change if the average orientation of the molecule or its ionic state changes. In solid-state NMR spectra, a Lorentzian peak shape is representative of nuclei that have a defined set or narrow range of orientations to the magnetic field. This is typically an indication of ordered or crystalline molecular structuring.

On the other hand, Gaussian peaks represent nuclei that have random and/or wide-ranging orientations with respect to the magnetic field. In solids, this is indicative of an amorphous arrangement of the molecules with the conformational disorder. As proton spins strongly couple to the spins of their bonded carbon nuclei, they influence the line shape and chemical shift of the 13C peak Each peak was fitted to a mixed Lorentzian and Gaussian function, where an L/G value of unity describes the line-shape as fully Lorentzian and zero as fully Gaussian.

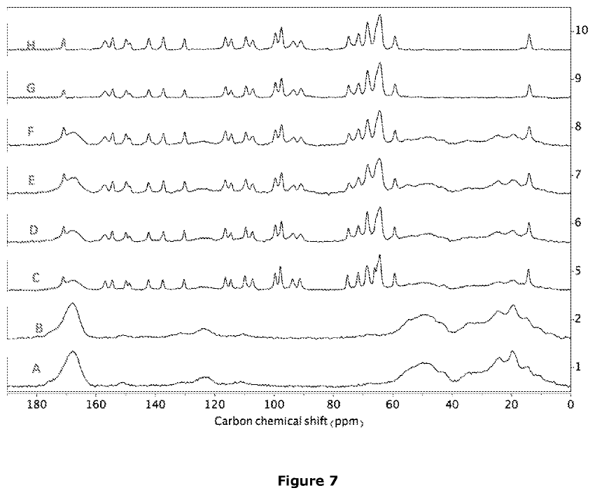

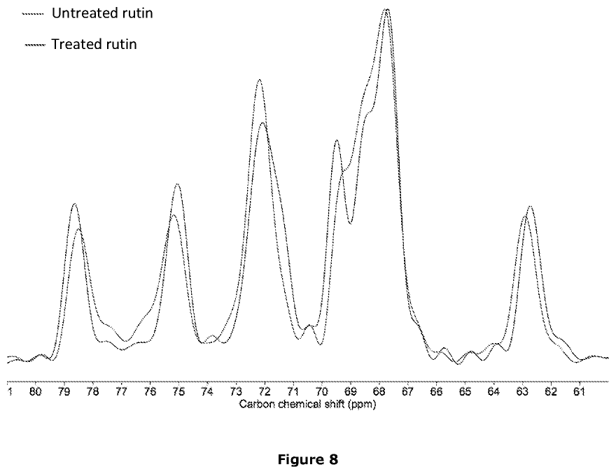

The ¹³C NMR spectra of untreated and treated samples, as well as the samples containing trehalose, are presented in FIG. 7. In addition, FIG. 8 contains the ¹³C NMR spectra of untreated and treated rutin with their peak assignments. These figures show the lack of molecular interactions between the caseins and rutin, as well as the effect of pH treatment on the crystallinity of rutin.

Firstly, there was no difference between the NMR spectra of untreated and treated NaCas (FIG. 7). Likewise, there seemed to be no detectable site (carbon species) specific interactions between rutin and NaCas in the rutin-NaCas co-precipitates indicating that the molecular mobility has not changed and so no interactions between the two molecules could be confirmed.

Along the above lines, the direct interactions (e.g. cation-n interactions) have been reported between some flavonoids and proteins, and generally, such properties of flavonoids are considered as a key function responsible for their biological activities (Munusami, 2014). Lysine and arginine in caseins, for example, which are positively charged at pH 4.6 (the precipitation point for both rutin and NaCas in the current experiment), can potentially interact with the benzene ring of rutin. However, such interactions were not found by NMR analysis. Further, hydrophobic interactions between flavonoids (e.g. curcumin and quercetin) and NaCas, casein micelles, and β-casein in the aqueous solutions have also been reported (Mehranfar, 2013) (Pan K. Z., 2013). But there is no evidence for any intimate association or interaction between the individual molecules of the co-precipitates of the invention and hence NMR observations are dominated by the bulk material rather than the surface-surface interactions of particles on rutin, NaCas, and when added, trehalose.

This means that rutin is physically entrapped in the protein matrix without molecular/chemical bonding. As the process of the invention includes a rapid acidification from alkaline pH, where both protein and flavonoid are dissociated/dissolved, to the isoelectric point of the protein, where both protein and flavonoid completely precipitate, there is little chance for molecular interactions between the two components to develop. In addition, the initial pH (alkaline) is not a desirable condition for possible hydrophobic or other interactions between proteins and flavonoids.

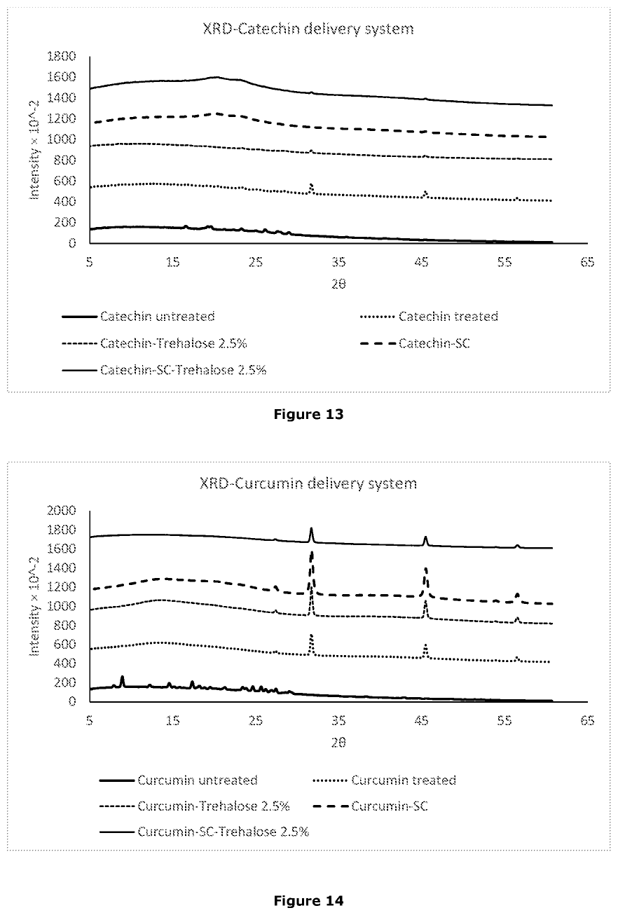

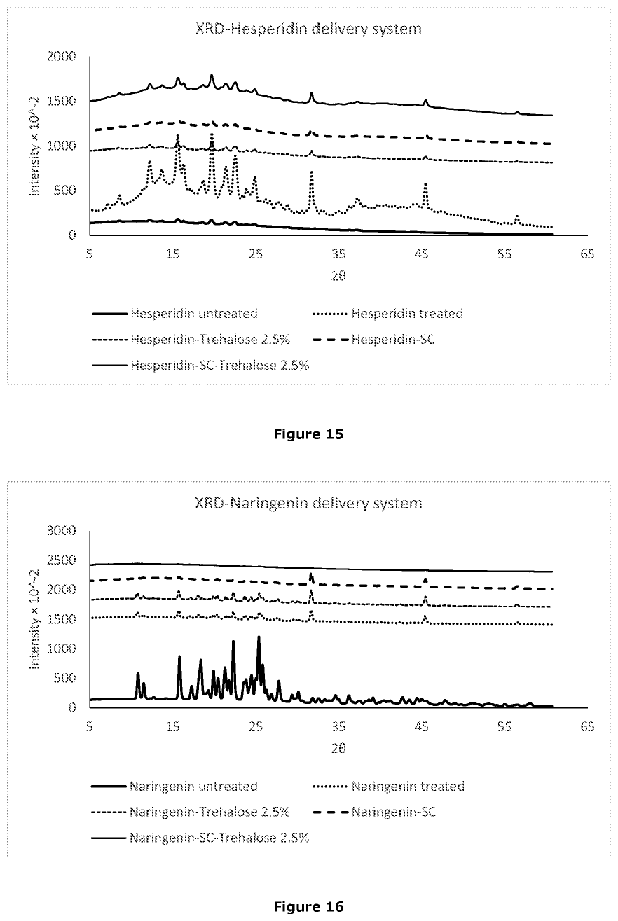

Secondly, as can be seen in FIG. 8, rutin carbon peaks (e.g. those numbered 2, 16, 21, 22, 23, 24) alter in line-shape, intensity, and the chemical shift after pH-treatment. The reduction in Lorentzian content of treated rutin indicates conformational heterogeneity consistent with a reduction of crystallinity and/or increase in amorphous material. Thus, these findings suggest that the molecular order of the carbons in the rutin molecule has been reduced. The disaccharide component of rutin is conformationally much more flexible, both in its unsaturated ring structure and the glycosidic connections, than the aromatic quercetin component. Proton sharing between hydroxyl groups on sugar rings is typically responsible for the formation of crystalline structures with sugars. Accordingly, the changes in the alternative hydrogen bonding arrangements, concomitant with the reduction or loss of crystallinity, lead to the observed changes in NMR spectra. These findings are well aligned with the XRD results presented in FIGS. 13-16.

### Example 7

### Preparation of Further Flavonoid-NaCas Co-Precipitates

Four additional flavonoid-NaCas co-precipitates and controls were prepared in accordance with the process of Example 1. Rutin was replaced with (a) catechin, (b) curcumin, (c) hesperidin and (d) naringenin in each of the processes. All of the solutions were lowered to pH 4.6 from pH 11 in the case of catechin, hesperidin and naringenin and to 4.6 from 11.5, in the case of curcumin.

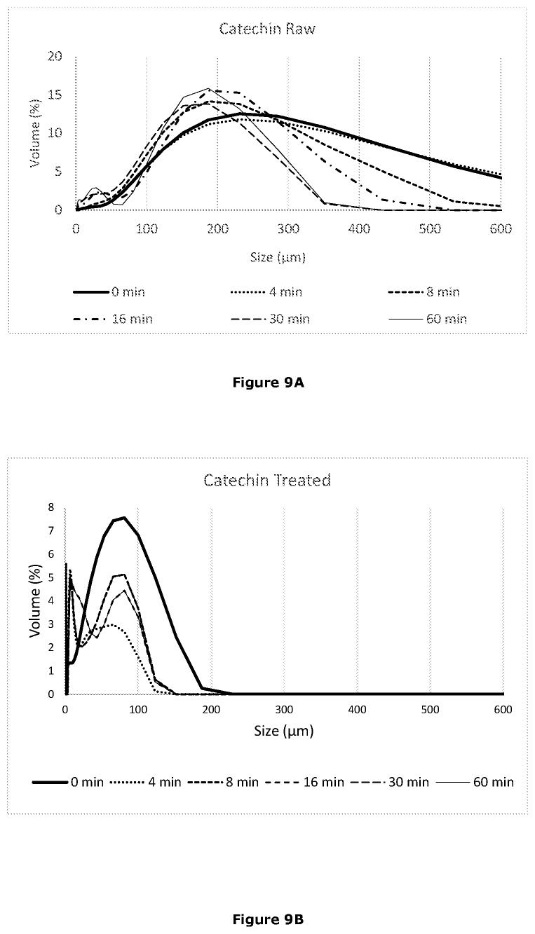

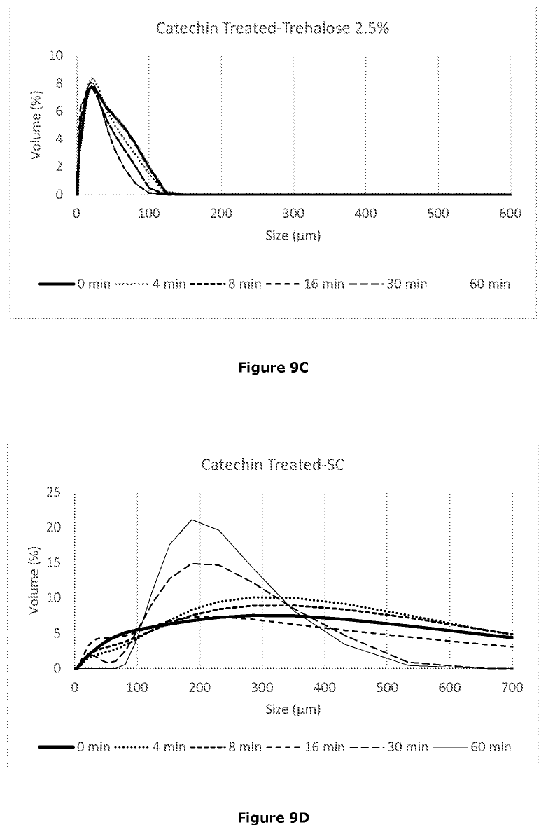

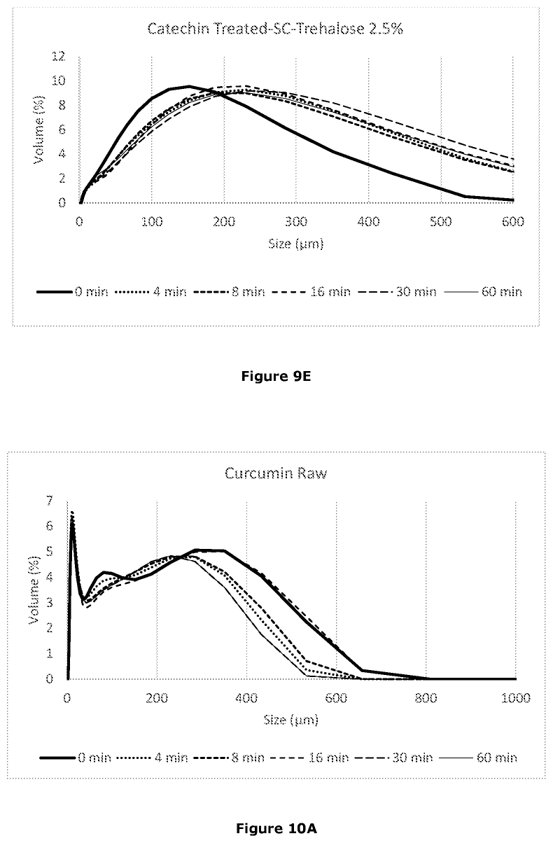

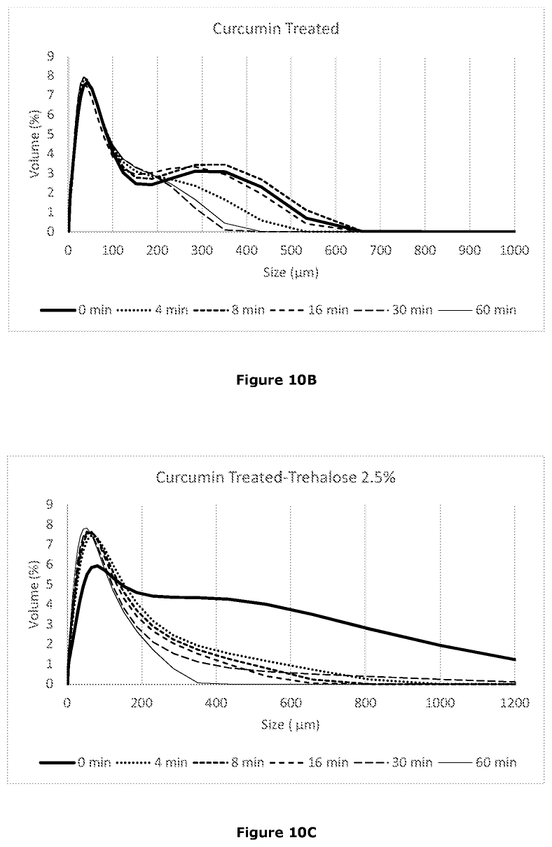

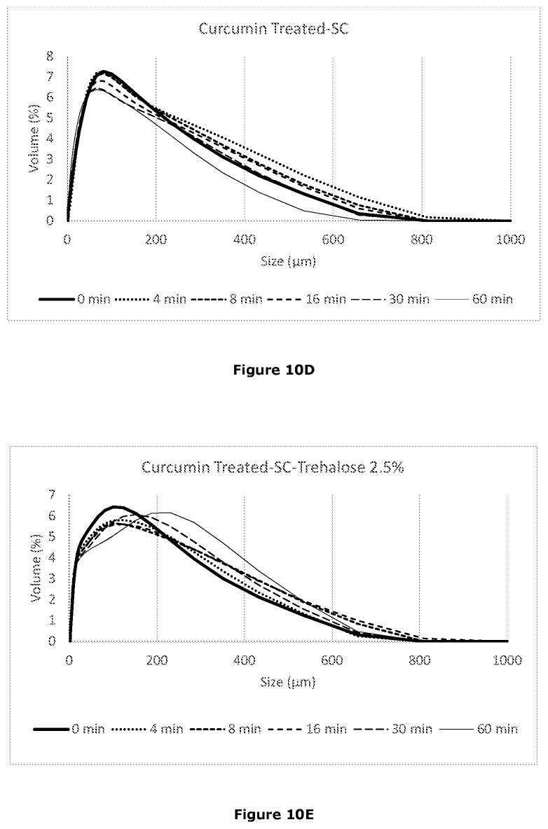

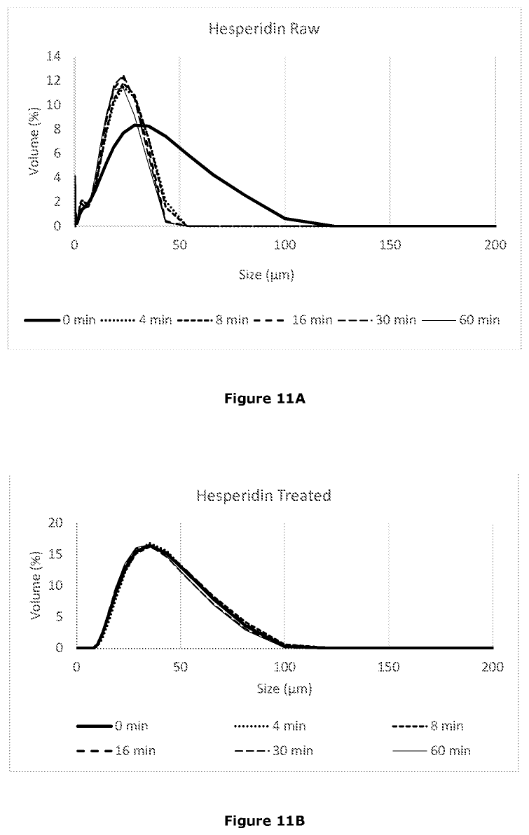

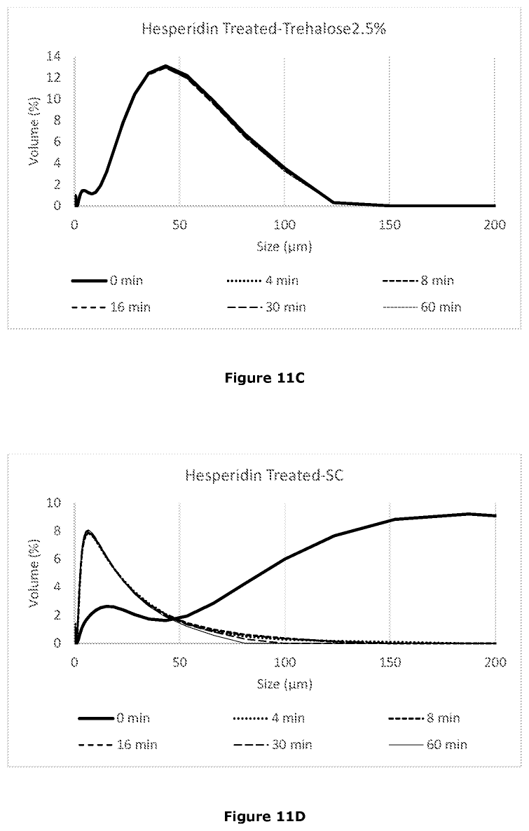

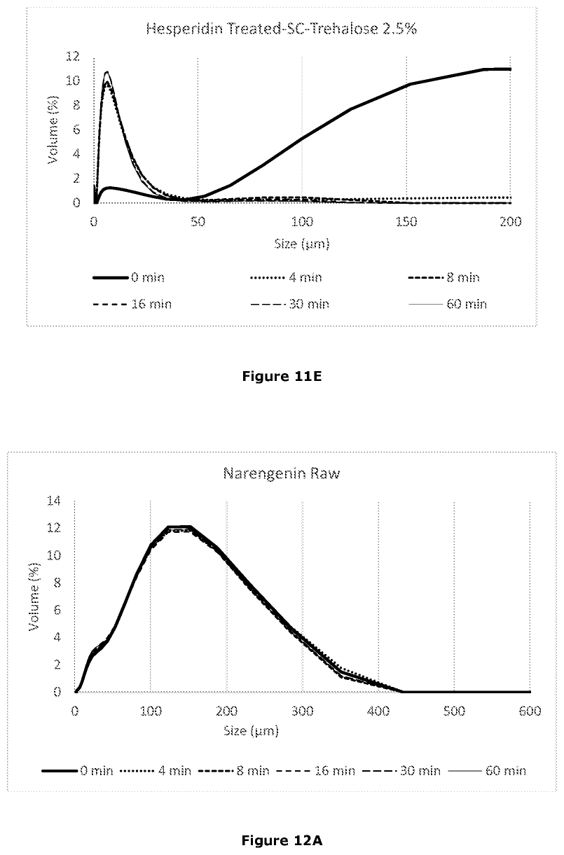

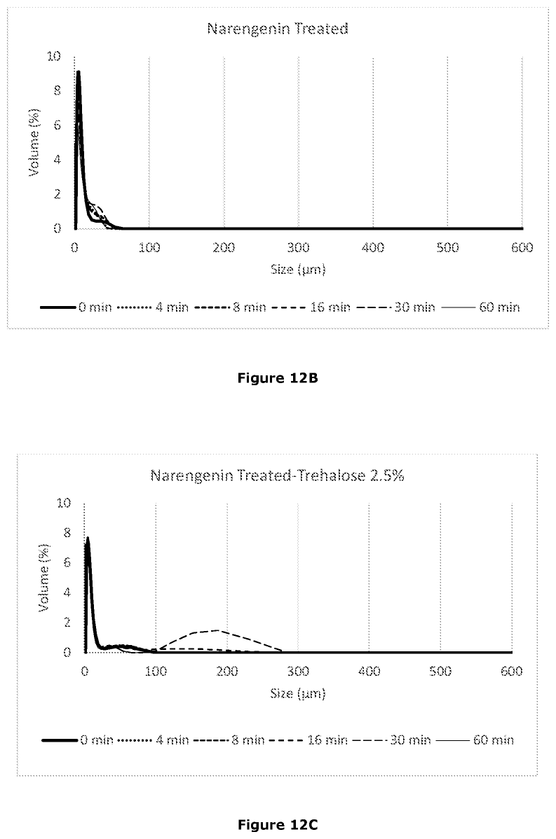

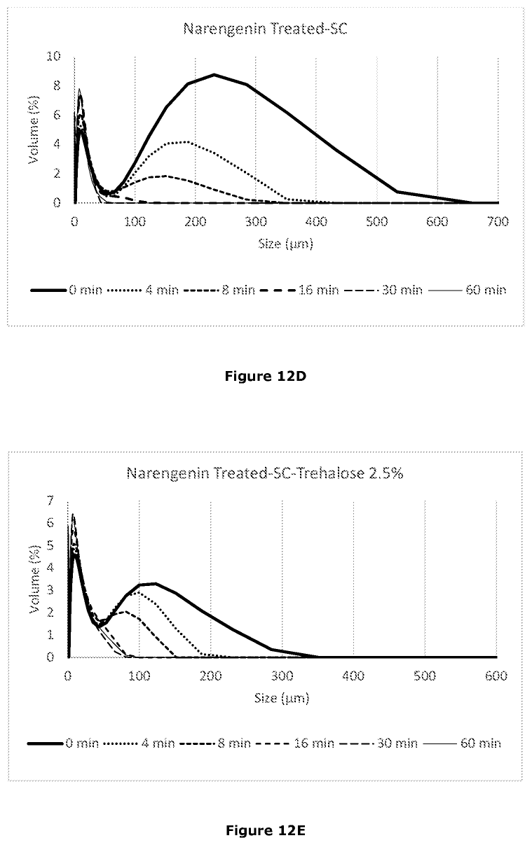

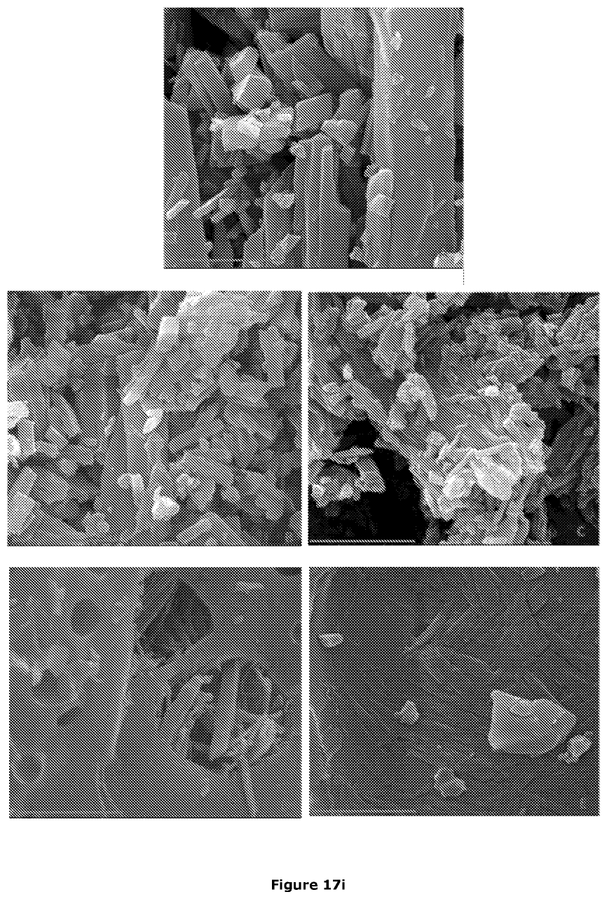

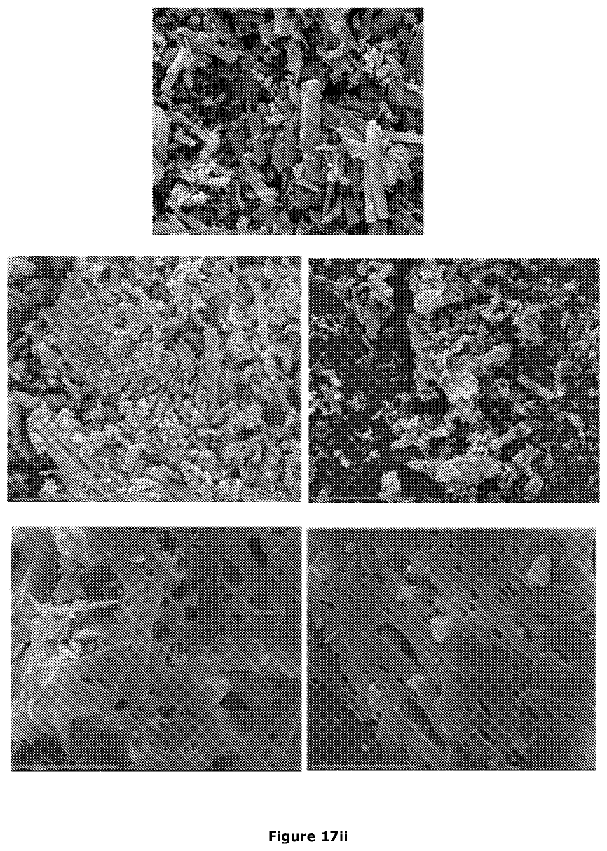

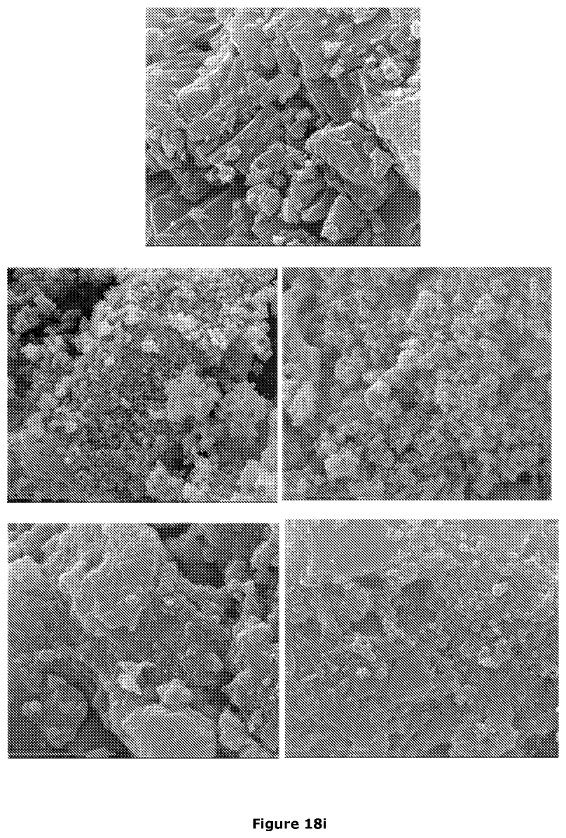

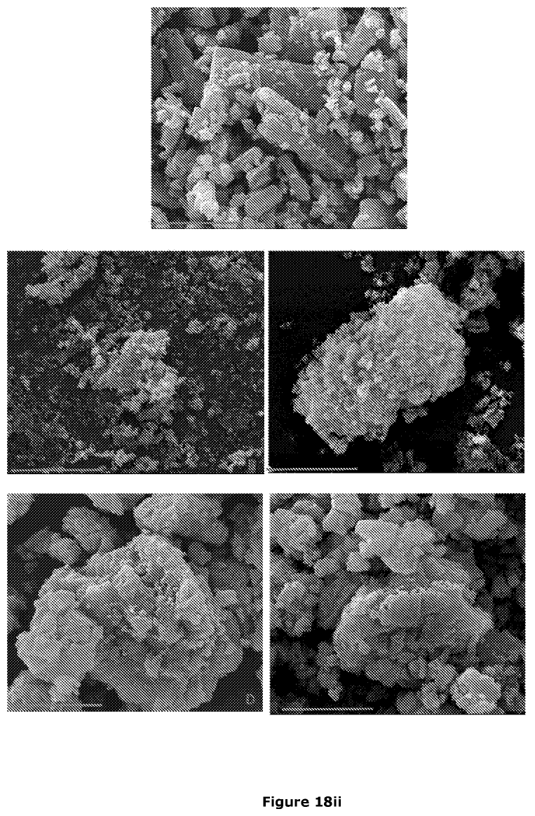

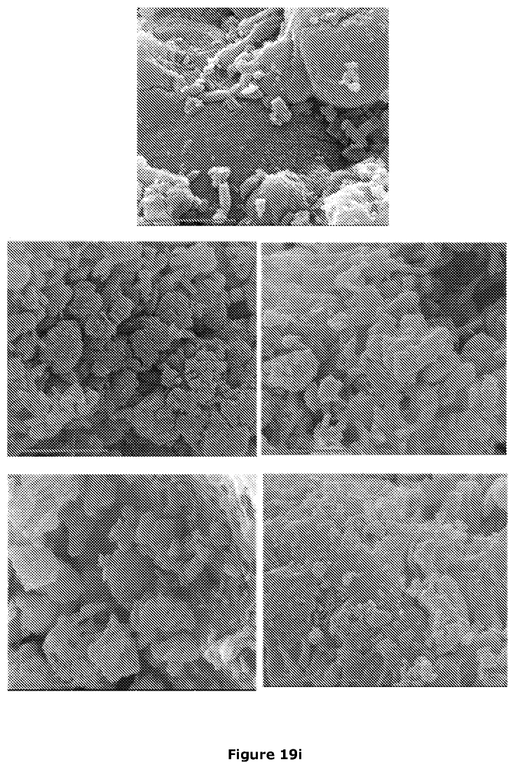

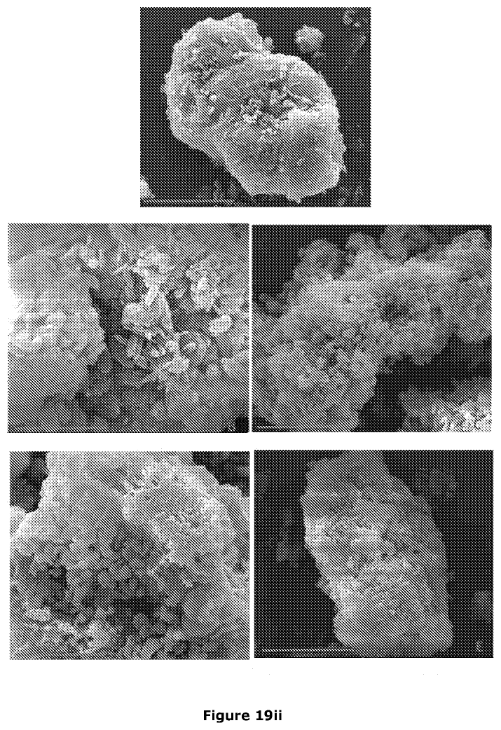

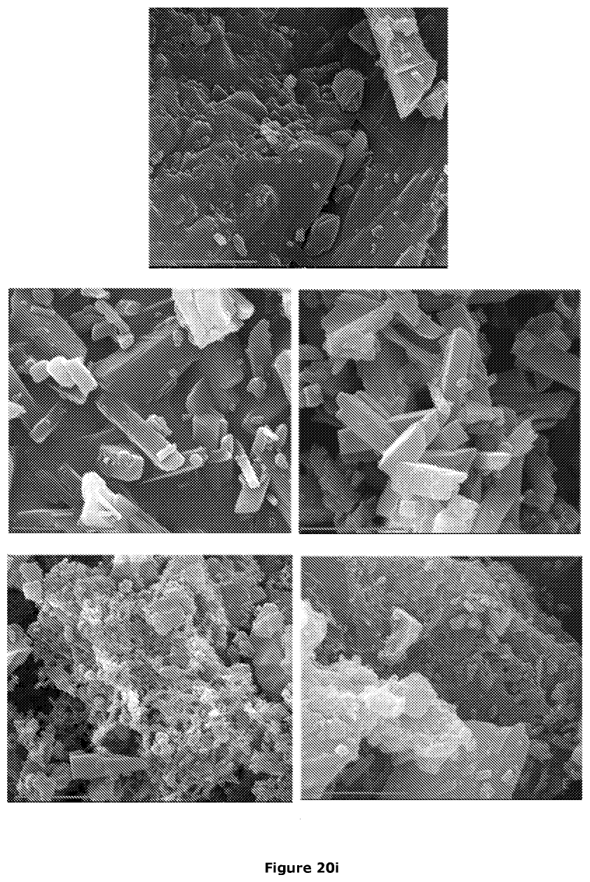

The dispersibility of each co-precipitate was measured as set out above. The results are shown in FIGS. 9-12. XRD analysis was also performed on each co-precipitate. The results are shown in FIGS. 13-16. The morphology of the four co-precipitates was determined using SEM, as shown in FIGS. 17-20.

The results for the four new flavonoid-NaCas co-precipitates are consistent with the data found for rutin-NaCas. These results indicate that the products of the invention are suitable delivery systems for other hydrophobic flavonoids and can be used to fortify food products with hydrophobic flavonoids generally.

### Example 8

### Industrial Manufacture of Stirred-Type Yogurts Fortified with FlavoPlus (NaCas:Rutin Co-Precipitate)

Two hundred and fifty litres of pasteurised and homogenised skim milk was heated to 45° C. in a stainless steel tank fixed with an agitator. Skim milk powder (4.6 Kg), FlavoPlus (1.76 Kg), pectin (0.43 Kg), vanilla flavour (0.72 Kg), potassium sorbate (0.14 Kg) and tartaric acid (0.06 Kg) were premixed and added to the tank, followed by the sweet taste modulator (0.23 Kg). Then the mixture was heated to 60° C. In the meanwhile, erythritol (9.94 Kg), sucralose (0.014) and gelatine (1.44 Kg) were premixed and added to the tank at 60° C., followed by the milkfat (5.44 Kg). The yoghurt mixture was stirred for 60 minutes. Then the mix was homogenised at 200 bar, 1-stage, and pumped into an empty tank. The pH of the mix was checked and adjust to 6.3 using 30% potassium hydroxide. The homogenised mix was heated to 85° C. for 30 minutes and then cooled to 42° C. A sachet of freeze-dried starter culture was aseptically opened and added into the tank and the mix was stirred for 15 minutes. Afterwards, the agitator heating system were shut off and fermentation was carried out at 42° C. for 8 hours, until reaching pH 4.6-4.5. Once fermentation finished, the resulting curd was cooled to 10° C. with agitation. Once the temperature was reached, the yoghurt was pumped from the fermentation tank to the hopper, where the pots were filled and thermos-sealed. Yoghurt pots were stored at 4° C. or below. The process is set out in FIG. 21.

### Example 9

### Consistency and Firmness of Yogurts Containing Rutin

A texture analysis of yoghurts produced in Example 8 was performed using a TA.XT plus texture analyser (Stable Micro Systems Ltd.) with a 5 Kg load cell adapted. The experiment was performed using a single compression test (distance: 30 mm, speed 0.001 ms-1) and a back-extrusion probe (diameter: 37 mm) at 5° C. The sample size was 50 g. The texture parameters analysed were firmness and consistency.

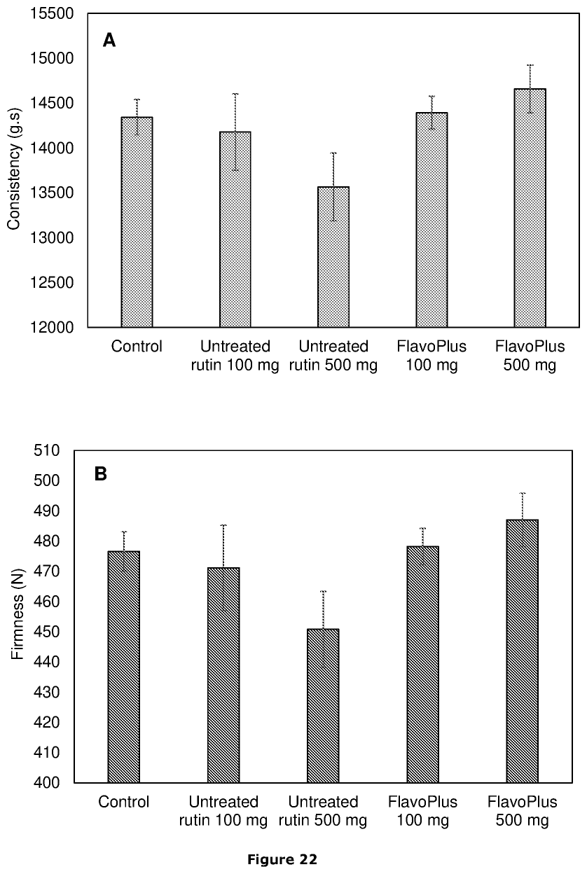

FIG. 22 shows the changes in consistency (A) and firmness (B) of yoghurts fortified with different concentrations of rutin in both FlavoPlus and untreated rutin (free rutin) form. These results demonstrate that rutin fortification at a low dose (100 mg) does not change the consistency or firmness of yoghurts, but there is a clear difference when using a high rutin dose (500 mg). Untreated rutin (free rutin) causes an unacceptable decrease in consistency and firmness of yogurts, whereas FlavoPlus does not have any effect. This indicates that FlavoPlus allows incorporating rutin at a high dose in yoghurts, having less effect on texture perception.

### Example 10

### Changes in pH and Rheological Properties of Rutin-Enriched Yoghurts During Fermentation

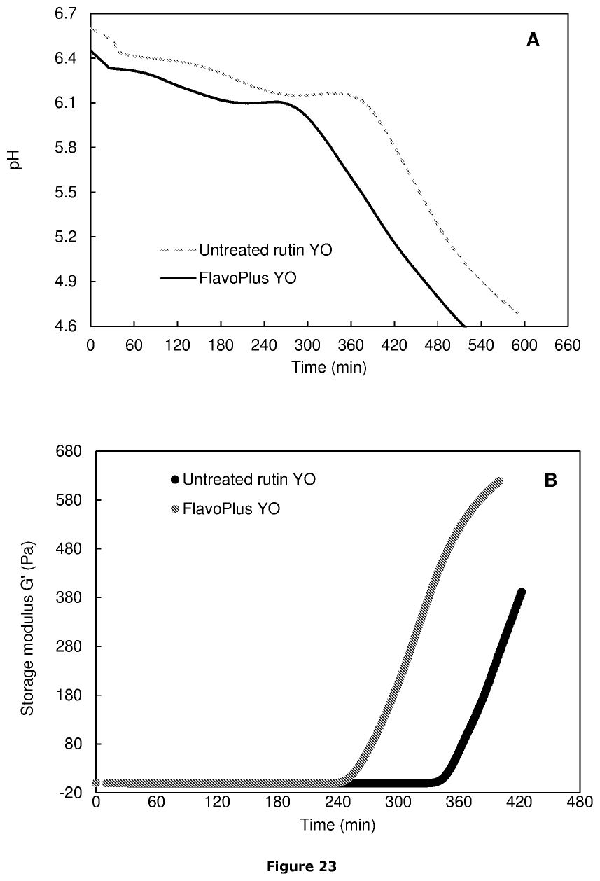

The pH of the samples of yogurt produced in Example 8 was regularly measured in a pH-stat titrator (TIM856, Titralab®, Radiometer Analytical, France) during the fermentation time. An aliquot of 60 mL of inoculated milk was placed in the sampling cell of the device and a pH probe was inserted inside. The pH change was monitored every 2 min. The results are shown in FIG. 23.

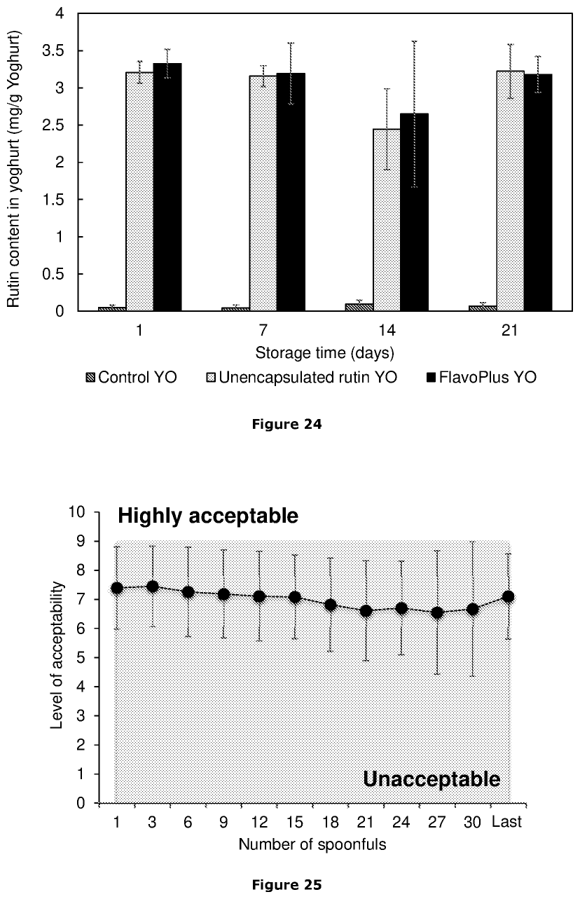

The rheological properties were monitored using a rheometer (AR-G2, TA Instruments, USA) fitted with a smart swap concentric cylinder system. During fermentation, the yoghurts were subjected to low amplitude dynamic oscillation measurements, with a frequency of 1 Hz and applied strain of 1% to avoid gel disruption. An aliquot of 12 mL of sample was transferred to the rheometer and mineral oil was applied to the surface to avoid evaporation. The temperature was 43° C. Data was collected every minute for 7 h. FIG. 24 shows the pH (A) and rheological properties (B) changes over time during yoghurt fermentation, using a formulation with FlavoPlus and another with untreated rutin (free rutin) that contained 500 mg, the highest rutin dose tested. The results show that the addition of untreated rutin at this dose delays the pH drop during fermentation when compared with FlavoPlus. In fact, while the FlavoPlus yoghurt formulation needs only about 500 minutes to reach pH 4.6, the time required for untreated rutin formulation is 600 minutes. Rheological properties, particularly the storage modulus (G′), also differs depending on the formulation. The G′ of yoghurts with FlavoPlus increased faster than in yoghurts fortified with untreated rutin (free rutin), indicating that the gelation process was much faster in FlavoPlus containing yoghurt

### Example 11

### Change in Rutin Concentration and Other Properties During Storage of Yogurts

The rutin concentration of the yogurts produced in Example 8 was measured. FIG. 24 presents rutin concentration in yoghurts stored for 21 days and the percentage of rutin recovered after extraction from control (without rutin), FlavoPlus, and untreated rutin (free rutin) yogurt formulations. The rutin concentration does not change significantly during storage in either formulation containing either FlavoPlus or untreated rutin.

As shown in Table 1, the percentage recovery is also similar in yoghurt formulations containing FlavoPlus and untreated rutin. These results suggest that rutin remains chemically stable in yoghurts during storage, but also that the entrapment procedure for manufacturing FlavoPlus does not compromise rutin chemical stability in the food product.

TABLE 1
Percentage of recovery of rutin from fortified yoghurts

Storage (days)

| Formulation | 1 day | 7 days | 14 days | 21 days |
|---|---|---|---|---|
| Control | 1 | 1 | 3 | 2 |
| FlavoPlus | 88 | 82 | 70 | 84 |
| Free rutin | 88 | 81 | 65 | 86 |

Another set of yoghurts was prepared according to Example 8 to assess storage stability of the product. The pH and titratable acidity of the yogurts was measured over 35 days and found to be within the relevant food standards (Standard 2.5.3, FSANZ and Codex standard 243-2003).

The water holding capacity (WHC) was measured over 40 days. A higher WHC indicates lower syneresis, which is a property of a high-quality yogurt. The viscosity and storage modulus of the fortified yogurt at 4° C. were also measured using standard techniques. The WHC, viscosity and storage modulus were all normal and acceptable.

### Example 12

### Sensory Properties of Yogurt Fortified with FlavoPlus

The sensory properties of the yogurts produced in Example 8 were tested. The sensory test applied was an affective test performed in one session. The experiment was carried out in the dining hall of Massey University. Forty-five untrained panellists participated, mostly university students and staff. They were instructed to rate the overall acceptability of the product and the effect of the serving size in their response. Panellists rated the level of acceptability every third spoonful until completing the serving size (190 g). A 9-cm bar scale was used, where 0 cm refers to ‘unacceptable’ and 9 cm is “highly acceptable”. Yoghurt pots were randomly coded and each pot was collected after the sensory test to measure any remaining amount of yoghurt.

FIG. 25 illustrates consumer acceptance as a function of the number of spoonsful of FlavoPlus fortified yoghurts, containing the highest dose tested (500 mg). The FlavoPlus formulation was sensory assessed by a 45-people consumer panel through an acceptance test. Consumers rated their sensory experience every certain number of spoonfuls, using a 9-point hedonic scale. Results obtained indicate that yoghurts fortified with FlavoPlus fall within the acceptance range and were palatable, and that this sensory perception was stable throughout the whole serving.

### Example 13

### Bench-Top Manufacture of Protein Bars Fortified with FlavoPlus

To prepare 100g of bar material, whey protein concentrate (34.2 g), protein crisps (10.3 g), soluble dietary fibre (14.8 g), polydextrose (6.8 g), FlavoPlus (1.8 g) and salt (0.2 g) were weighted and premixed into a plastic bag. Glycerol (11.4g), sorbitol (11.4 g), and water (1.9 g) were mixed and heated in a stainless steel container to 60° C. Canola oil (6.5 g) and lecithin (0.6 g) were mixed in a separate container and heated to 60° C. Dry ingredients in the plastic bag were added into a mixing bowl. The warm glycerol-sorbitol-water mix was added to the mixing bowl, followed by the oily mix. All ingredients were blended with a Hobart style mixer at low speed for 1 minute. The powder caked on the bowl's surface was removed with a spatula and the ingredients were mixed for 1 minute. The resulting paste was transferred to a tray, previously coated by baking paper, and levelled off with a roller. The product was left to rest overnight at room temperature. Finally, the product was cut with a plastic cutter into 55 g-pieces. The bars can be vacuum sealed and stored at room temperature. The process is illustrated in FIG. 26.

### Example 14

### Bench-Top/Pilot Plant Manufacture of Protein Beverages Fortified with FlavoPlus

To prepare 1000 mL of beverage, water (531.2 mL), antifoam (0.35 g) and glucose (94 g) were mixed and heated to 50° C. Whey protein concentrate (57 g), milk protein concentrate (57 g) and FlavoPlus (4 g) were weighted and added to the water-glucose mix, at low speed stirring to minimise foaming. Beverage mixture was mixed for 60 minutes at 50° C. In a separate stainless steel container, sugar (94 g), water (132.8 mL), carboxyl methylcellulose (2 g) and carrageenan (0.1 g) were blended until dissolving, and this premix was added to the protein mixture at 50° C. Canola oil (52 g) and lecithin (1.6 g) were also blended, pre-warmed to 50° C. and added to the protein mixture. The beverage was then heated to 60° C., homogenised at 200/50 bar, 2-stage and cooled to 20-25° C. The pH was adjusted to 6.8 using 10% potassium hydroxide and beverage was heat treated by UHT (140° C., 60 seconds) or pasteurisation (85° C., 15 seconds). The beverage was pumped to the filling machine and aseptically packed in 250 mL plastic bottles. The process is illustrated in FIG. 27.

### Example 15

### Preparation of a Range of Hydrophobic Flavonoid: Protein Co-Precipitates

A range of flavonoid:protein co-precipates was made in accordance with Example 1 using hydrophobic flavonoids rutin, naringenin, hesperidin, curcumin and catechin and proteins NaCas, WPI and SPI, MPC and pea protein isolate.

The water solubility of the flavonoid in the following co-precipitates was investigated: rutin:NaCas, rutin:SPI, rutin:WPI, naringenin:NaCas, naringenin:SPI, naringenin:WPI, curcumin:NaCas, curcumin:SPI, curcumin:WPI, catechin:NaCas, catechin:SPI and catechin:WPI.

The water solubility of the flavonoid in the co-precipitates of the invention (with and without 2.5% trehalose) was compared with that of the untreated hydrophobic flavonoid and the treated flavonoid (in which the flavonoid was dissolved at high pH and then precipitated by lowering the pH to about 4.6).

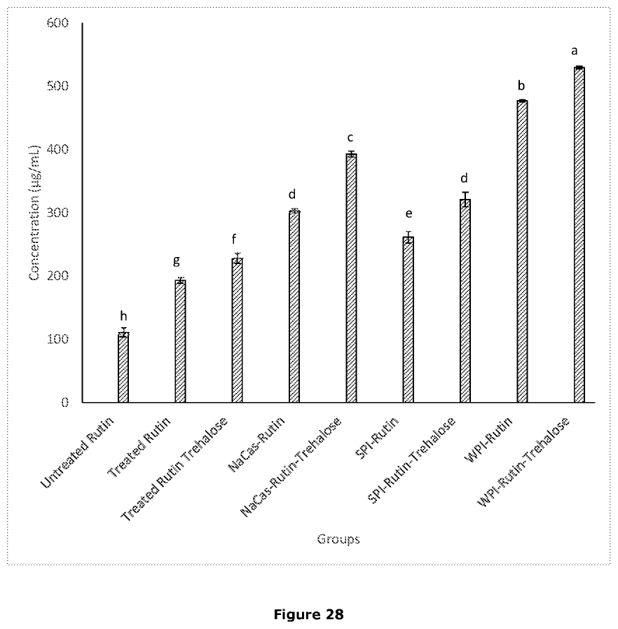

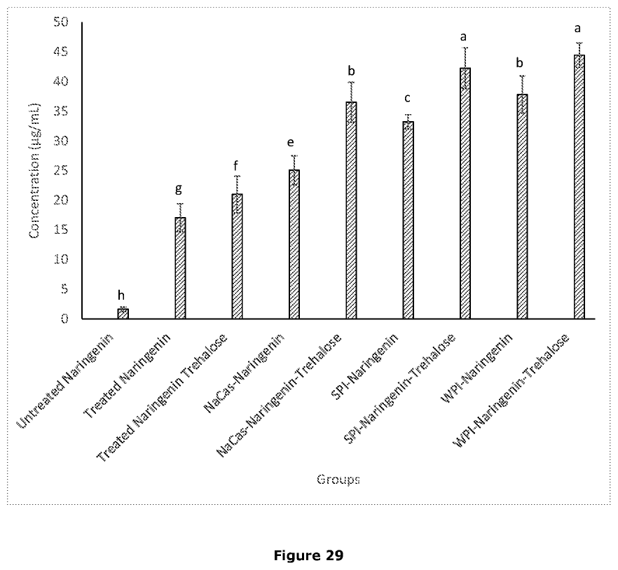

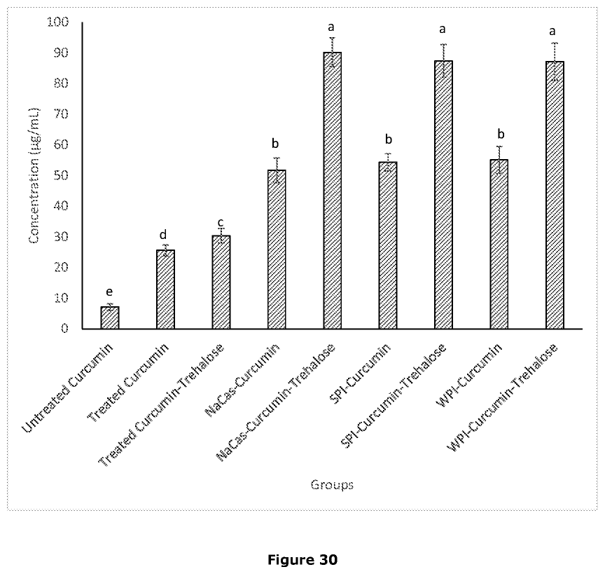

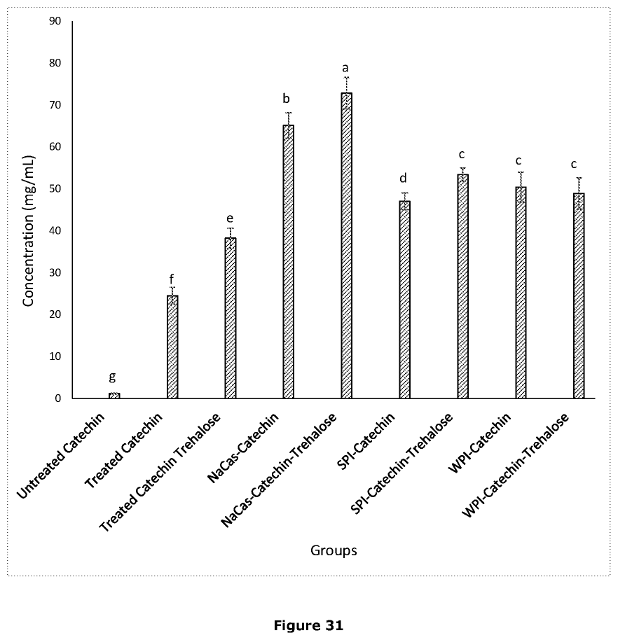

The results are shown in FIGS. 28 to 31. The results indicate that hydrophobic flavonoids originating from the co-precipitates of the invention are consistently more soluble than the equivalent untreated or treated hydrophobic flavonoid.

XRD analysis was also performed on each co-precipitate, with the WPI and SPI co-precipitates giving consistent results with the NaCas co-precipitate XRD data shown in FIGS. 13-16. The dispersibility of the co-precipitates was also investigated, both without trehalose and with 2.5 or 5 wt % trehalose. The dispersibility results obtained were similar to the dispersibility of flavonioid:NaCas co-precipitate shown in FIGS. 2 and 9 to 12.

### Example 16

### Spray-Drying NaCas:Rutin Co-Precipitates Dispersed in Phosphate Solution

One litre of a 10% (w/v) aqueous solution of sodium caseinate (NaCas) was prepared and left to fully hydrate overnight. The solution was then brought to pH 11.0 using 4 M NaOH and left stirring (300 rpm) at room temperature for 30 min for the complete dissociation of NaCas. 100 g (10%, w/v) of food-grade rutin was added to this solution and the pH was increased to 11.0 again, as rutin decreased the pH dramatically.

The mixture was stirred at room temperature until all of the added rutin was dissolved while the pH of the solution was constantly monitored and adjusted to 11.0, when required. From the time that all of the rutin was dissolved in the NaCas solution, the mixed solution was stirred for another 30 min while the pH was continually monitored.

The solution (containing rutin, NaCas, and trehalose where added) was acidified rapidly to pH 4.6 (the pI of caseins) using 4 M HCl, causing the rutin and NaCas to co-precipitate. The resulting mixture was centrifuged at 3000 g at room temperature for 10 min.

The co-precipitated product (10% dry wt/v) was then dispersed in a potassium phosphate solution and spray dried under the following conditions: inlet temperature 180° C., outlet temperature 75° C., flow rate 20 mL/min.

### Example 17

### Particle Size and Solubility of NaCas:Rutin Co-Precipitates Dispersed in Phosphate Solutions (Spray Dried Powders)

A NaCas: rutin co-precipitate was prepared in accordance with Example 16. The co-precipitated product was dispersed in a range of potassium phosphate solutions to give 10% wt/v co-precipitate, which was then spray dried, as set out in Example 16.

The potassium phosphate solutions used were of various concentrations of potassium phosphate (0.1 to 5% w/v)

A control precipitate of rutin was prepared using the same process as described in Example 16 omitting the protein component. The rutin concentration in the solution, was 10% w/v). Following the acidification of the solution, rutin formed a precipitate which was tested against the co-precipitates of the invention.

The spray dried powder products were assessed using the Dispersibility and Solubility protocols provided above. The results are shown in FIGS. 32 and 33. These results show that the additional step of spray drying co-precipitates dispersed in phosphate solution provides a flavonoid delivery system in which the flavonoid is particularly soluble and dispersible.

### Example 18

### Sensory Attributes and Consumers Choice of Dairy Products Fortified with FlavoPlus (Spray Dried Powders)

A set of yogurt formulations was prepared with and without addition of rutin in various forms (no-rutin added, untreated rutin, NaCas:rutin co-precipitate-freeze dried, and NaCa:rutin co-precipitate dissolved in phosphate solution and spray dried). These yogurts were prepared in accordance with Example 8.

Overall liking of these yoghurts were determined using a 9-point hedonic scale. Participants were asked to choose one of the three rutin enriched products (untreated rutin, NaCas:rutin co-precipitate-freeze dried, and NaCa:rutin co-precipitate dissolved in phosphate solution and spray dried) to take back home. It was found that 60% of the participants (n=40) preferred the yogurt fortified with NaCas:rutin co-precipitate dissolved in phosphates to take back home.

Similar results were found for vanilla-flavoured milks fortified with different rutin ingredients (no-rutin added, untreated rutin, NaCas:rutin co-precipitate-freeze dried, and NaCa:rutin co-precipitate dissolved in phosphate solution and spray dried). The formulation made with NaCas:rutin co-precipitate dissolved in phosphate and spray dried was selected as the preferred choice by participants over the others.

### 7. REFERENCES

Dammak, I. &. (2017). Formulation and stability characterization of rutin-loaded oil-in-water emulsions. Food and Bioprocess Technology, 10(5), 926-939.
Fang, Y. S. (2011). On quantifying the dissolution behaviour of milk protein concentrate. Food Hydrocolloids, 25(3), 503-510.
Ji, J. F. (2016). Rehydration behaviours of high protein dairy powders: The influence of agglomeration on wettability, dispersibility and solubility. Food Hydrocolloids, 58, 194-203.
Mehranfar, F. B. (2013). A combined spectroscopic, molecular docking and molecular dynamic simulation study on the interaction of quercetin with β-casein nanoparticles. Journal of Photochemistry and Photobiology B: Biology, 12.
Munusami, P. I. (2014). Molecular docking studies on flavonoid compounds: an insight into aromatase inhibitors. International Journal of Pharmacy and Pharmaceutical Sciences, 6(10), 141-148.
Pan, K. L. (2014). pH-driven encapsulation of curcumin in self-assembled casein nanoparticles for enhanced dispersibility and bioactivity. Soft Matter, 10(35), 6820-6830.
Pan, K. Z. (2013). Enhanced dispersibility and bioactivity of curcumin by encapsulation in casein nanocapsules. Journal of Agriculture Food Chemistry, 61(25), 6036-6043.

1. A flavonoid delivery system comprising a co-precipitate of a hydrophobic flavonoid and a protein.

2. The flavonoid delivery system of claim 1 wherein the co-precipitate comprises
the hydrophobic flavonoid entrapped in a protein matrix.

3. The flavonoid delivery system of claim 2 wherein the co-precipitate comprises
nanocrystals of the hydrophobic flavonoid entrapped in the protein matrix.

4. The flavonoid delivery system of claim 1 wherein the co-precipitate has been dispersed in a phosphate solution and spray dried.

5. The flavonoid delivery system of claim 1, wherein the hydrophobic flavonoid and the protein are selected such that they both precipitate from aqueous solution at an isoelectric point of the protein.

6. The flavonoid delivery system of claim 1 wherein the hydrophobic flavonoid has a hydrophobicity of about 2 to about 4 and/or is soluble in aqueous solution at high pH, preferably above 10.

7. The flavonoid delivery system of claim 1 wherein the hydrophobic flavonoid is selected from rutin, naringenin, quercetin, curcumin, hesperidin, alpha-naphthoflavone (ANF), beta-naphthoflavone (BNF), catechin and catechin derivatives, chrysin, luteolin, myricetin and anthocyanins.

8. The flavonoid delivery system of claim 1 wherein the protein has an isoelectric point of about 4 to about 6.5.

9. The flavonoid delivery system of claim 1 wherein the protein is selected from sodium caseinate, soy protein isolate, pea protein isolate, denatured whey protein isolate and milk protein isolate.

10. The flavonoid delivery system of claim 1 wherein a mass ratio of protein:flavonoid in the co-precipitate is about 4:1 to about 0.5:1.

11. The flavonoid delivery system of claim 1 that comprises about 1.0 to about 5 wt % consumable cryoprotectant, preferably selected from trehalose, sucrose, glucose, mannitol, lactose, fructose, and glycerol, preferably 2.5 wt %. trehalose.

12. A process for producing the co-precipitate of claim 1, the process comprising the steps of:
(a) preparing an aqueous solution of a hydrophobic flavonoid and a protein at a starting pH of about 9 to about 12 to obtain a mixture,
(b) stirring the mixture of (a) until the hydrophobic flavonoid has dissolved, while maintaining pH of the mixture at about the starting pH;
(c) optionally adding a consumable cryoprotectant to the mixture and stirring the mixture until the consumable cryoprotectant is dissolved;
(d) acidifying the mixture to about an isoelectric point of the protein, thereby causing the flavonoid and the protein to co-precipitate;
(e) removing the supernatant to obtain the co-precipitate.

13. (canceled)

14. The process of claim 12 which further comprises dispersing the co-precipitate obtained in step (e) in a phosphate solution to obtain a dispersion and spray drying the dispersion to provide a powder.

15. (canceled)

16. The process of claim 12 wherein concentration of the protein in the aqueous solution of step (a) is about 1 to about 15% (w/v)
and concentration of the hydrophobic flavonoid in the aqueous solution of step (a) is about 1 to about 15% (w/v).

17. (canceled)

18. The process of claim 12 wherein a ratio of the protein to the hydrophobic flavonoid is about 4:1 to about 0.5:1.

19.-20. (canceled)

21. The process of claim 12 that has an LC of about 25 to about 49%.

22. (canceled)

23. A composition comprising the flavonoid delivery system of claim 1 dispersed in a phosphate solution.

24. A food product comprising the flavonoid delivery system of claim 1 or the composition of claim 22.

25. The food product of claim 24 comprising about 0.1 to about 3.5 wt % of the flavonoid delivery system.

26. The food product of claim 24 comprising about 0.1 to about 0.6 wt % hydrophobic flavonoid.
